(19) United States
(12) Patent Application Publication
(10) Pub. No.: US 2025/0126524 A1
(43) Pub. Date: Apr. 17, 2025

(54) MULTI-PRIMARY CHANNEL ACCESS OPERATION

(71) Applicant: QUALCOMM Incorporated, San Diego, CA (US)

(72) Inventors: Gaurang NAIK, San Diego, CA (US); Abhishek Pramod PATIL, San Diego, CA (US); George CHERIAN, San Diego, CA (US); Alfred ASTERJADHI, San Diego, CA (US); Sai Yiu Duncan HO, San Diego, CA (US); Yanjun SUN, San Diego, CA (US); Abdel Karim AJAMI, San Diego, CA (US)

(21) Appl. No.: 18/485,097

(22) Filed: Oct. 11, 2023

(51) Int. Cl. H04W 28/26; H04W 72/0446; H04W 74/04; H04W 84/12

(52) U.S. Cl. CPC H04W 28/26; H04W 72/0446; H04W 74/04; H04W 84/12

(57) ABSTRACT

This disclosure provides methods, components, devices and systems for multi-primary channel access operation. Some aspects more specifically relate to improving the efficiency of multi-primary channel access schemes. In some implementations, the first wireless device may use multiple primary subchannels. A first wireless device may receive a first signaling indicating a first reservation of a first transmission opportunity (TXOP) for a second wireless device on a first primary channel. The first wireless device may obtain a second TXOP to transmit or receive, via a second primary channel, a second signaling indicating a second reservation of the second TXOP. The ending time of the second TXOP may occur prior to an ending time of the first reservation and prior to a transition delay associated with a communication event scheduled on the first subset of channels or a second subset of channels.

### TECHNICAL FIELD

This disclosure relates to wireless communication and, more specifically, to multi-primary channel access operation.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

In some WLANs, a wireless device (such as an AP or a STA) may contend for access to a wireless channel. If the wireless medium is occupied, the wireless device may switch to another wireless channel and refrain from using the occupied channel for a period of time.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communication at a first wireless device. The method may include receiving, a first signaling indicating a first reservation of a first transmission opportunity (TXOP) for a second wireless device on a first primary channel of a first bandwidth, the first bandwidth comprising a first plurality of channels that are reservable by the first primary channel, the first signaling indicating an ending time of the first reservation.

One innovative aspect of the subject matter described in this disclosure can be implemented in a method for wireless communication at a first wireless device. The method may include transmitting or receiving, via a second primary channel, a second signaling indicating a second reservation of the second TXOP. The ending time of the second TXOP (such as when the first wireless device ends or terminates the second TXOP) may occur prior to an ending time of the first reservation. Additionally, or alternatively, the ending time of the second TXOP may occur prior to a transition delay (TD) associated with a communication event (such as one or more epochs where and when the first wireless device may be expected to perform one or more functions) scheduled on the first subset of channels or a second subset of channels.

One innovative aspect of the subject matter disclosed in this disclosure can be implemented in a method for wireless communication at a first wireless device.

A method for wireless communication by a first wireless device is described. The method may include receiving a first signaling indicating a first reservation of a first transmission opportunity for a second wireless device on a first primary channel of a first bandwidth, the first bandwidth including a first set of multiple channels that are reservable via the first primary channel, the first signaling indicating an ending time of the first reservation and transmitting or receiving, via a second primary channel, a second signaling indicating a second reservation of a second transmission opportunity, where an ending time of the second transmission opportunity occurs prior to the ending time of the first reservation and prior to a start of a transition delay associated with a communication event scheduled on one of the first set of multiple channels or on one of a second set of multiple channels of a second bandwidth.

A first wireless device for wireless communication is described. The first wireless device may include a processing system that includes processor circuitry and memory circuitry that stores code. The processing system may be configured to cause the first wireless device to receive a first signaling indicating a first reservation of a first transmission opportunity for a second wireless device on a first primary channel of a first bandwidth, the first bandwidth including a first set of multiple channels that are reservable via the first primary channel, the first signaling indicating an ending time of the first reservation and transmit or receive, via a second primary channel, a second signaling indicating a second reservation of a second transmission opportunity, where an ending time of the second transmission opportunity occurs prior to the ending time of the first reservation and prior to a start of a transition delay associated with a communication event scheduled on one of the first set of multiple channels or on one of a second set of multiple channels of a second bandwidth.

Another first wireless device for wireless communication is described. The first wireless device may include means for receiving a first signaling indicating a first reservation of a first transmission opportunity for a second wireless device on a first primary channel of a first bandwidth, the first bandwidth including a first set of multiple channels that are reservable via the first primary channel, the first signaling indicating an ending time of the first reservation and means for transmitting or receiving, via a second primary channel, a second signaling indicating a second reservation of a second transmission opportunity, where an ending time of the second transmission opportunity occurs prior to the ending time of the first reservation and prior to a start of a transition delay associated with a communication event scheduled on one of the first set of multiple channels or on one of a second set of multiple channels of a second bandwidth.

A non-transitory computer-readable medium storing code for wireless communication is described. The code may include instructions executable by a processor to receive a first signaling indicating a first reservation of a first transmission opportunity for a second wireless device on a first primary channel of a first bandwidth, the first bandwidth including a first set of multiple channels that are reservable via the first primary channel, the first signaling indicating an ending time of the first reservation and transmit or receive, via a second primary channel, a second signaling indicating a second reservation of a second transmission opportunity, where an ending time of the second transmission opportunity occurs prior to the ending time of the first reservation and prior to a start of a transition delay associated with a communication event scheduled on one of the first set of multiple channels or on one of a second set of multiple channels of a second bandwidth.

Some examples of the method, first wireless devices, and non-transitory computer-readable medium described herein may further include operations, features, means, or instructions for transmitting or receiving one or more packets, during the second transmission opportunity, prior to the ending time of the second transmission opportunity in accordance with the second signaling.

In some examples of the method, first wireless devices, and non-transitory computer-readable medium described herein, the transition delay may be associated with switching from the second primary channel to the first primary channel and the communication event may be scheduled on one of the first set of multiple channels.

In some examples of the method, first wireless devices, and non-transitory computer-readable medium described herein, the transition delay may be associated with switching from the second primary channel to the first primary channel and the communication event may be scheduled on one of the second set of multiple channels.

In some examples of the method, first wireless devices, and non-transitory computer-readable medium described herein, the first set of multiple channels and the second set of multiple channels may be associated with a non-simultaneous transmit and receive link pair, an enhanced multi-link single radio link set, or an enhanced multi-link multi radio link set.

In some examples of the method, first wireless devices, and non-transitory computer-readable medium described herein, the transition delay may be associated with an enhanced multi-link single radio transition delay or an enhanced multi-link multi radio transition delay.

In some examples of the method, first wireless devices, and non-transitory computer-readable medium described herein, the transition delay may be indicated in one or more management frames.

Some examples of the method, first wireless devices, and non-transitory computer-readable medium described herein may further include operations, features, means, or instructions for receiving a third signaling indicating a third reservation of a third transmission opportunity, where a second communication event may be scheduled to occur during the third transmission opportunity on one of the first set of multiple channels or on one of the second set of multiple channels and transmitting a response to the second signaling, where the response indicates a refusal to communicate during at least a portion of the third transmission opportunity.

Some examples of the method, first wireless devices, and non-transitory computer-readable medium described herein may further include operations, features, means, or instructions for receiving, from the second wireless device or from a third wireless device, a third signaling indicating a third reservation of a third transmission opportunity, where a second communication event may be scheduled to occur during the third transmission opportunity on one of the first set of multiple channels or on one of the second set of multiple channels and transmitting an instruction to the second wireless device or the third wireless device to refrain from transmitting during at least a portion of the third transmission opportunity.

Some examples of the method, first wireless devices, and non-transitory computer-readable medium described herein may further include operations, features, means, or instructions for receiving a third signaling indicating a third reservation of a third transmission opportunity, where a second communication event may be scheduled to occur during the third transmission opportunity on one of the first set of multiple channels or on one of the second set of multiple channels and refraining from transmitting a response to the third signaling based on the second communication event being scheduled to occur during the third transmission opportunity.

In some examples of the method, first wireless devices, and non-transitory computer-readable medium described herein, the second communication event may be a dynamic event.

In some examples of the method, first wireless devices, and non-transitory computer-readable medium described herein, the transition delay may be zero.

In some examples of the method, first wireless devices, and non-transitory computer-readable medium described herein, the communication event may be a target beacon transmission beam scheduled on one of the first set of multiple channels or one of the second set of multiple channels, a target wake time service period scheduled on one of the first set of multiple channels, or a target wake time service period scheduled on one of the second set of multiple channels.

In some examples of the method, first wireless devices, and non-transitory computer-readable medium described herein, the communication event may be a restricted target wake time service period associated with the first primary channel that applies to the second primary channel or a coordinated restricted target wake time service period associated with the first primary channel that applies to the second primary channel.

In some examples of the method, first wireless devices, and non-transitory computer-readable medium described herein, the communication event may be a coordinated restricted target wake time service period associated with the first primary channel and the method, apparatuses, and non-transitory computer-readable medium may include further operations, features, means, or instructions for transmitting or receiving a third signaling indicating whether the communication event applies to the second primary channel, a third primary channel of the second bandwidth, or any combination thereof.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows a hierarchical format of an example PPDU usable for communications between a wireless AP and one or more wireless STAs.

FIG. 3 shows an example of a resource diagram that supports multi-primary channel access operation.

FIG. 4 shows an example of a resource diagram that supports multi-primary channel access operation.

FIG. 5 shows an example of a resource diagram that supports multi-primary channel access operation.

FIG. 6 shows an example of a resource diagram that supports multi-primary channel access operation.

FIG. 7 shows an example of a resource diagram that supports multi-primary channel access operation.

FIG. 8 shows an example of a resource diagram that supports multi-primary channel access operation.

FIG. 9 shows an example of a resource diagram that supports multi-primary channel access operation.

FIG. 10 shows an example of a resource diagram that supports multi-primary channel access operation.

FIG. 11 shows an example of a resource diagram that supports multi-primary channel access operation.

FIG. 12 shows an example of a resource diagram that supports multi-primary channel access operation.

FIG. 13 shows a block diagram of an example wireless communication device that supports multi-primary channel access operation.

FIG. 14 shows a flowchart illustrating an example process performable by or at a first wireless device that supports multi-primary channel access operation.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IoT) network.

Various aspects relate generally to improving the efficiency of multi-primary channel access schemes. Some aspects more specifically relate to communication for a first wireless device, such as an access point (AP) or a station (STA) that supports multi-primary channel access and/or other modes of operation (e.g., such as enhanced multi-link single-radio (EMLSR), a non-simultaneous transmit and receive (NSTR), or an enhanced multi-link multi radio (EMLMR)). In some implementations, the first wireless device may use multiple primary subchannels (such as a main primary (M-Primary) channel and an opportunistic primary (O-Primary). For example, a first wireless device may receive a first signaling indicating a first reservation (such as by an overlapping basic service set (OBSS) transmission) of a first transmission opportunity (TXOP) for a second wireless device on a first primary channel (such as a M-Primary channel) of a first bandwidth. The first bandwidth may include a first set of channels.

In some implementations, the first wireless device may obtain a second TXOP to transmit or receive, via a second primary channel (such as an O-Primary channel), a second signaling (such as an initial control frame (ICF)) indicating a second reservation of the second TXOP (such as on the second primary channel). The ending time of the second TXOP (such as when the first wireless device ends or terminates the second TXOP) may occur prior to an ending time of the first reservation (such as the first TXOP). Additionally, or alternatively, the ending time of the second TXOP may occur prior to a transition delay (TD) associated with a communication event (such as at least a duration of TD before one or more epochs where and when the first wireless device may be expected to perform one or more functions) scheduled on the first subset of channels or a second subset of channels. The TD may be the time it takes for the first wireless device to switch back from the second primary channel (such as the O-Primary channel) to the original first primary channel (such as the M-Primary channel) if the communication event is scheduled on the first subset of channels (such as on the same link). Additionally, or alternatively, the TD may be the time it takes for the first wireless device to switch from the second primary channel to a M-Primary channel (which may be the original first primary channel or another primary channel associated with the communication event) if the communication event is scheduled on the second subset of channels (such as on another link). Thus, the first wireless device may switch from an O-Primary channel to a M-Primary channel and effectively perform one or more functions on the requisite M-Primary channel.

In some implementations, by an ending time of a second TXOP (for example on an O-Primary channel) occurring prior to a start of a TD associated with a communication event on a M-Primary channel, the described techniques may enable wireless devices to perform multi-primary channel access and/or other modes of operation (e.g., such as EMLSR, NSTR, or EMLMR). with greater signaling efficiency, reduced latency, and lower resource overhead. For example, if the ending time of the second TXOP occurs after the TD associated with the communication event, the first wireless device may not have enough time to perform one or more functions (such as transmit or receive a beacon). Thus, the techniques described herein may improve the overall throughput, performance, and reliability of communication within the system.

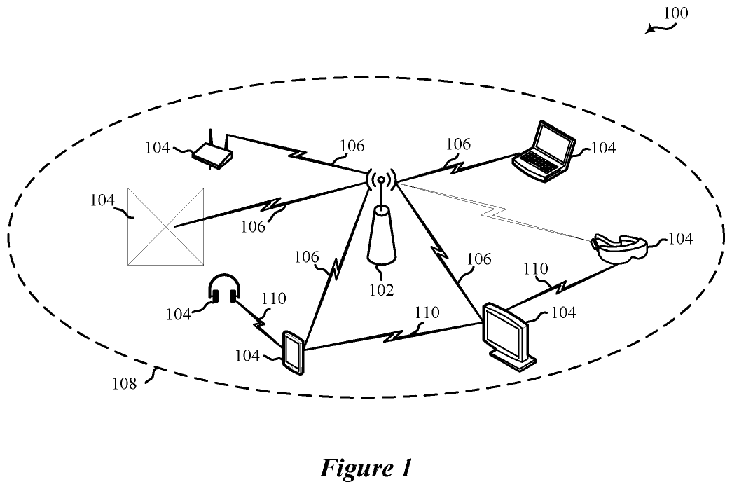

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bd, 802.11be, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core.

The wireless communication network 100 may include numerous wireless communication devices including at least one wireless AP 102 and any number of wireless STAs 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHZ, 6 GHz, 45 GHZ, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some implementations, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some implementations, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the WLAN wireless communication network 100 may transmit PPDUs over an unlicensed spectrum, which may be a portion of spectrum that includes frequency bands traditionally used by Wi-Fi technology, such as the 2.4 GHz, 5 GHZ, 6 GHZ, 45 GHZ, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHZ-7.125 GHZ), FR2 (24.25 GHZ-52.6 GHZ), FR3 (7.125 GHZ-24.25 GHZ), FR4a or FR4-1 (52.6 GHZ-71 GHZ), FR4 (52.6 GHZ-114.25 GHZ), and FR5 (114.25 GHZ-300 GHZ).

Each of the frequency bands may include multiple sub-bands and frequency channels (also referred to as subchannels). For example, PPDUs conforming to the IEEE 802.11n, 802.11ac, 802.11ax, 802.11be and 802.11bn standard amendments may be transmitted over one or more of the 2.4 GHZ, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHZ, 80 MHZ, 160 MHZ, 240 MHZ, 320 MHz, 480 MHz, or 640 MHz by bonding together multiple 20 MHz channels.

In some implementations, the AP 102 or the STAs 104 of the wireless communication network 100 may implement Extremely High Throughput (EHT) or other features compliant with current and future generations of the IEEE 802.11 family of wireless communication protocol standards (such as the IEEE 802.11be and 802.11bn standard amendments) to provide additional capabilities over other previous systems (for example High Efficiency (HE) systems or other legacy systems). For example, the IEEE 802.11be standard amendment introduced 320 MHz channels, which are twice as wide as those possible with the IEEE 802.11ax standard amendment. Accordingly, the AP 102 or the STAs 104 may use 320 MHz channels enabling double the throughput and network capacity, as well as providing rate versus range gains at high data rates due to linear bandwidth versus log SNR trade-off. EHT and newer wireless communication protocols (such as the protocols referred to as or associated with the IEEE 802.11bn standard amendment) may support flexible operating bandwidth enhancements, such as broadened operating bandwidths relative to legacy operating bandwidths or more granular operation relative to legacy operation. For example, an EHT system may allow communications spanning operating bandwidths of 20 MHz, 40 MHZ, 80 MHZ, 160 MHz, 240 MHZ, and 320 MHz. EHT systems may support multiple bandwidth modes such as a contiguous 240 MHz bandwidth mode, a contiguous 320 MHz bandwidth mode, a noncontiguous 160+160 MHz bandwidth mode, or a noncontiguous 80+80+80+80 (or “4×80”) MHz bandwidth mode.

In some examples in which a wireless communication device (such as the AP 102 or the STA 104) operates in a contiguous 320 MHz bandwidth mode or a 160+160 MHz bandwidth mode, signals for transmission may be generated by two different transmit chains of the wireless communication device each having or associated with a bandwidth of 160 MHZ (and each coupled to a different power amplifier). In some other examples, two transmit chains can be used to support a 240 MHz/160+80 MHz bandwidth mode by puncturing 320 MHz/160+160 MHz bandwidth modes with one or more 80 MHz subchannels. For example, signals for transmission may be generated by two different transmit chains of the wireless communication device each having a bandwidth of 160 MHz with one of the transmit chains outputting a signal having an 80 MHz subchannel punctured therein. In some other examples in which the wireless communication device may operate in a contiguous 240 MHZ bandwidth mode, or a noncontiguous 160+80 MHz bandwidth mode, the signals for transmission may be generated by three different transmit chains of the wireless communication device, each having a bandwidth of 80 MHz. In some other examples, signals for transmission may be generated by four or more different transmit chains of the wireless communication device, each having a bandwidth of 80 MHZ.

In noncontiguous examples, the operating bandwidth may span one or more disparate sub-channel sets. For example, the 320 MHz bandwidth may be contiguous and located in the same 6 GHz band or noncontiguous and located in different bands or regions within a band (such as partly in the 5 GHz band and partly in the 6 GHz band).

In some implementations, the AP 102 or the STA 104 may benefit from operability enhancements associated with EHT and newer generations of the IEEE 802.11 family of wireless communication protocol standards. For example, the AP 102 or the STA 104 attempting to gain access to the wireless medium of wireless communication network 100 may perform techniques (which may include modifications to existing rules, structure, or signaling implemented for legacy systems) such as clear channel assessment (CCA) operation based on EHT enhancements such as increased bandwidth, puncturing, or refinements to carrier sensing and signal reporting mechanisms.

According to some aspects of the present disclosure, a first wireless device (such as an AP 102 or a STA 104) may receive a first signaling (e.g., OBSS transmission) indicating a first reservation of a first TXOP for a second wireless device (such as a STA 104 or an AP 102) on a first primary channel (such as an O-Primary Channel). The first primary channel may correspond to a first bandwidth including a first set of channels. A wireless device (such as the first wireless device, the second wireless device, or both) may reserve the first primary channel. The first wireless device may transmit or receive, via a second primary channel (such as a M-Primary channel) a second signaling (e.g., a short frame, an initial control frame (ICF)) indicating a second reservation of a second TXOP. The ending time of the second TXOP (such as when the first wireless device ends or terminates the second TXOP) may occur prior to the ending time of the first TXOP. Additionally, or alternatively, the ending time of the second TXOP may occur prior to a start of a TD associated with a communication event (such as one or more epochs). The communication event may be scheduled on the first subset of channels or a second subset of channels. Thus, the first wireless device may switch from the O-Primary channel to a M-Primary channel (which may be the original M-Primary channel associated with the first subset of channels or another M-Primary channel associated with the second subset of channels) and perform one or more functions on the M-Primary channel.

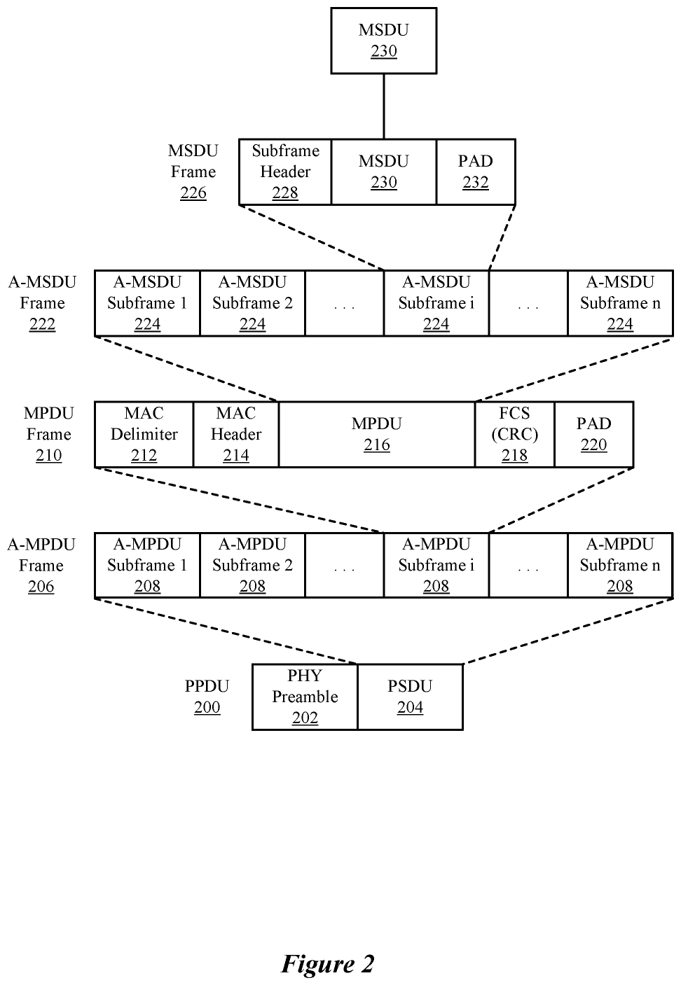

FIG. 2 shows a hierarchical format of an example PPDU usable for communications between a wireless AP and one or more wireless STAs. For example, the AP and STAs may be examples of the AP 102 and the STAs 104 described with reference to FIG. 1. As described, each PPDU 200 includes a PHY preamble 202 and a PSDU 204. Each PSDU 204 may represent (or “carry”) one or more MAC protocol data units (MPDUs) 216. For example, each PSDU 204 may carry an aggregated MPDU (A-MPDU) 206 that includes an aggregation of multiple A-MPDU subframes 208. Each A-MPDU subframe 206 may include an MPDU frame 210 that includes a MAC delimiter 212 and a MAC header 214 prior to the accompanying MPDU 216, which includes the data portion (“payload” or “frame body”) of the MPDU frame 210. Each MPDU frame 210 also may include a frame check sequence (FCS) field 218 for error detection (for example the FCS field may include a cyclic redundancy check (CRC)) and padding bits 220. The MPDU 216 may carry one or more MAC service data units (MSDUs) 216. For example, the MPDU 216 may carry an aggregated MSDU (A-MSDU) 222 including multiple A-MSDU subframes 224. Each A-MSDU subframe 224 contains a corresponding MSDU 230 preceded by a subframe header 228 and in some cases followed by padding bits 232.

Referring back to the MPDU frame 210, the MAC delimiter 212 may serve as a marker of the start of the associated MPDU 216 and indicate the length of the associated MPDU 216. The MAC header 214 may include multiple fields containing information that defines or indicates characteristics or attributes of data encapsulated within the frame body 216. The MAC header 214 includes a duration field indicating a duration extending from the end of the PPDU until at least the end of an acknowledgment (ACK) or Block ACK (BA) of the PPDU that is to be transmitted by the receiving wireless communication device. The use of the duration field serves to reserve the wireless medium for the indicated duration, and enables the receiving device to establish its network allocation vector (NAV). The MAC header 214 also includes one or more fields indicating addresses for the data encapsulated within the frame body 216. For example, the MAC header 214 may include a combination of a source address, a transmitter address, a receiver address or a destination address. The MAC header 214 may further include a frame control field containing control information. The frame control field may specify a frame type, for example, a data frame, a control frame, or a management frame.

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it may wait for a particular time and then contend for access to the wireless medium. The DCF is implemented through the use of time intervals (including the slot time (or “slot interval”) and the inter-frame space (IFS). IFS provides priority access for control frames used for proper network operation. Transmissions may begin at slot boundaries. Different varieties of IFS exist including the short IFS (SIFS), the distributed IFS (DIFS), the extended IFS (EIFS), and the arbitration IFS (AIFS). The values for the slot time and IFS may be provided by a suitable standard specification, such as one or more of the IEEE 802.11 family of wireless communication protocol standards.

In some implementations, the wireless communication device (such as the AP 102 or the STA 104) may implement the DCF through the use of carrier sense multiple access (CSMA) with collision avoidance (CA) (CSMA/CA) techniques. According to such techniques, before transmitting data, the wireless communication device may perform a clear channel assessment (CCA) and may determine (such as identify, detect, ascertain, calculate, or compute) that the relevant wireless channel is idle. The CCA includes both physical (PHY-level) carrier sensing and virtual (MAC-level) carrier sensing. Physical carrier sensing is accomplished via a measurement of the received signal strength of a valid frame, which is then compared to a threshold to determine (such as identify, detect, ascertain, calculate, or compute) whether the channel is busy. For example, if the received signal strength of a detected preamble is above a threshold, the medium is considered busy. Physical carrier sensing also includes energy detection. Energy detection involves measuring the total energy the wireless communication device receives regardless of whether the received signal represents a valid frame. If the total energy detected is above a threshold, the medium is considered busy.

Virtual carrier sensing is accomplished via the use of a network allocation vector (NAV), which effectively serves as a time duration that elapses before the wireless communication device may contend for access even in the absence of a detected symbol or even if the detected energy is below the relevant threshold. The NAV is reset each time a valid frame is received that is not addressed to the wireless communication device. When the NAV reaches 0, the wireless communication device performs the physical carrier sensing. If the channel remains idle for the appropriate IFS, the wireless communication device initiates a backoff timer, which represents a duration of time that the device senses the medium to be idle before it is permitted to transmit. If the channel remains idle until the backoff timer expires, the wireless communication device becomes the holder (or “owner”) of a transmit opportunity (TXOP) and may begin transmitting. The TXOP is the duration of time the wireless communication device can transmit frames over the channel after it has “won” contention for the wireless medium. The TXOP duration may be indicated in the U-SIG field of a PPDU. If, on the other hand, one or more of the carrier sense mechanisms indicate that the channel is busy, a MAC controller within the wireless communication device will not permit transmission.

Each time the wireless communication device generates a new PPDU for transmission in a new TXOP, it randomly selects a new backoff timer duration. The available distribution of the numbers that may be randomly selected for the backoff timer is referred to as the contention window (CW). There are different CW and TXOP durations for each of the four access categories (ACs): voice (AC_VO), video (AC_VI), background (AC_BK), and best effort (AC_BE). This enables particular types of traffic to be prioritized in the network.

In some other examples, the wireless communication device (such as the AP 102 or the STA 104) may contend for access to the wireless medium of WLAN 100 in accordance with an enhanced distributed channel access (EDCA) procedure. A random channel access mechanism such as EDCA may afford high-priority traffic a greater likelihood of gaining medium access than low-priority traffic. The wireless communication device using EDCA may classify data into different access categories. Each AC may be associated with a different priority level and may be assigned a different range of random backoffs (RBOs) so that higher priority data is more likely to win a TXOP than lower priority data (such as by assigning lower RBOs to higher priority data and assigning higher RBOs to lower priority data). Although EDCA increases the likelihood that low-latency data traffic will gain access to a shared wireless medium during a given contention period, unpredictable outcomes of medium access contention operations may prevent low-latency applications from achieving certain levels of throughput or satisfying certain latency requirements.

Some APs and STAs (such as the AP 102 and the STAs 104 described with reference to FIG. 1) may implement techniques for spatial reuse that involve participation in a coordinated communication scheme. According to such techniques, an AP 102 may contend for access to a wireless medium to obtain control of the medium for a TXOP. The AP that wins the contention (hereinafter also referred to as a “sharing AP”) may select one or more other APs (hereinafter also referred to as “shared APs”) to share resources of the TXOP. The sharing and shared APs may be located in proximity to one another such that at least some of their wireless coverage areas at least partially overlap. Some examples may specifically involve coordinated AP TDMA or OFDMA techniques for sharing the time or frequency resources of a TXOP. To share its time or frequency resources, the sharing AP may partition the TXOP into multiple time segments or frequency segments each including respective time or frequency resources representing a portion of the TXOP. The sharing AP may allocate the time or frequency segments to itself or to one or more of the shared APs. For example, each shared AP may utilize a partial TXOP assigned by the sharing AP for its uplink or downlink communications with its associated STAs.

In some examples of such TDMA techniques, each portion of a plurality of portions of the TXOP includes a set of time resources that do not overlap with any time resources of any other portion of the plurality of portions of the TXOP. In such examples, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some examples of OFDMA techniques, each portion of the plurality of portions of the TXOP includes a set of frequency resources that do not overlap with any frequency resources of any other portion of the plurality of portions. In such examples, the scheduling information may include an indication of frequency resources, of multiple frequency resources of the TXOP, associated with each portion of the TXOP. For example, the scheduling information may include an indication of a bandwidth portion of the wireless channel such as an indication of one or more subchannels or resource units associated with each portion of the TXOP such as for multi-user OFDMA.

In this manner, the sharing AP's acquisition of the TXOP enables communication between one or more additional shared APs and their respective BSSs, subject to appropriate power control and link adaptation. For example, the sharing AP may limit the transmit powers of the selected shared APs such that interference from the selected APs does not prevent STAs associated with the TXOP owner from successfully decoding packets transmitted by the sharing AP. Such techniques may be used to reduce latency because the other APs may not need to wait to win contention for a TXOP to be able to transmit and receive data according to conventional CSMA/CA or enhanced distributed channel access (EDCA) techniques. Additionally, by enabling a group of APs 102 associated with different BSSs to participate in a coordinated AP transmission session, during which the group of APs may share at least a portion of a single TXOP obtained by any one of the participating APs, such techniques may increase throughput across the BSSs associated with the participating APs and also may achieve improvements in throughput fairness. Furthermore, with appropriate selection of the shared APs and the scheduling of their respective time or frequency resources, medium utilization may be maximized or otherwise increased while packet loss resulting from OBSS interference is minimized or otherwise reduced. Various implementations may achieve these and other advantages without requiring that the sharing AP or the shared APs be aware of the STAs 104 associated with other BSSs, without requiring a preassigned or dedicated master AP or preassigned groups of APs, and without requiring backhaul coordination between the APs participating in the TXOP.

In some examples in which the signal strengths or levels of interference associated with the selected APs are relatively low (such as less than a given value), or when the decoding error rates of the selected APs are relatively low (such as less than a threshold), the start times of the communications among the different BSSs may be synchronous. Conversely, when the signal strengths or levels of interference associated with the selected APs are relatively high (such as greater than the given value), or when the decoding error rates of the selected APs are relatively high (such as greater than the threshold), the start times may be offset from one another by a time period associated with decoding the preamble of a wireless packet and determining, from the decoded preamble, whether the wireless packet is an intra-BSS packet or is an OBSS packet. For example, the time period between the transmission of an intra-BSS packet and the transmission of an OBSS packet may allow a respective AP (or its associated STAs) to decode the preamble of the wireless packet and obtain the BSS color value carried in the wireless packet to determine whether the wireless packet is an intra-BSS packet or an OBSS packet. In this manner, each of the participating APs and their associated STAs may be able to receive and decode intra-BSS packets in the presence of OBSS interference.

In some implementations, the sharing AP may perform polling of a set of un-managed or non-co-managed APs that support coordinated reuse to identify candidates for future spatial reuse opportunities. For example, the sharing AP may transmit one or more spatial reuse poll frames as part of determining one or more spatial reuse criteria and selecting one or more other APs to be shared APs. According to the polling, the sharing AP may receive responses from one or more of the polled APs. In some specific examples, the sharing AP may transmit a coordinated AP TXOP indication (CTI) frame to other APs that indicates time and frequency of resources of the TXOP that can be shared. The sharing AP may select one or more candidate APs upon receiving a coordinated AP TXOP request (CTR) frame from a respective candidate AP that indicates a desire by the respective AP to participate in the TXOP. The poll responses or CTR frames may include a power indication, for example, a receive (RX) power or RSSI measured by the respective AP. In some other examples, the sharing AP may directly measure potential interference of a service supported (such as UL transmission) at one or more APs, and select the shared APs based on the measured potential interference. The sharing AP generally selects the APs to participate in coordinated spatial reuse such that it still protects its own transmissions (which may be referred to as primary transmissions) to and from the STAs in its BSS. The selected APs may then be allocated resources during the TXOP as described above.

Retransmission protocols, such as hybrid automatic repeat request (HARQ), also may offer performance gains. A HARQ protocol may support various HARQ signaling between transmitting and receiving wireless communication devices (such as the AP 102 and the STAs 104 described with reference to FIG. 1) as well as signaling between the PHY and MAC layers to improve the retransmission operations in a WLAN. HARQ uses a combination of error detection and error correction. For example, a HARQ transmission may include error checking bits that are added to data to be transmitted using an error-detecting (ED) code, such as a cyclic redundancy check (CRC). The error checking bits may be used by the receiving device to determine if it has properly decoded the received HARQ transmission. In some implementations, the original data (information bits) to be transmitted may be encoded with a forward error correction (FEC) code, such as using a low-density parity check (LDPC) coding scheme that systematically encodes the information bits to produce parity bits. The transmitting device may transmit both the original information bits as well as the parity bits in the HARQ transmission to the receiving device. The receiving device may be able to use the parity bits to correct errors in the information bits, thus avoiding a retransmission.

Implementing a HARQ protocol in a WLAN may improve reliability of data communicated from a transmitting device to a receiving device. The HARQ protocol may support the establishment of a HARQ session between the two devices. Once a HARQ session is established, if a receiving device cannot properly decode (and cannot correct the errors) a first HARQ transmission received from the transmitting device, the receiving device may transmit a HARQ feedback message to the transmitting device (for example a negative acknowledgement (NACK)) that indicates at least part of the first HARQ transmission was not properly decoded. Such a HARQ feedback message may be different than the traditional Block ACK feedback message type associated with conventional ARQ. In response to receiving the HARQ feedback message, the transmitting device may transmit a second HARQ transmission to the receiving device to communicate at least part of further assist the receiving device in decoding the first HARQ transmission. For example, the transmitting device may include some or all of the original information bits, some or all of the original parity bits, as well as other, different parity bits in the second HARQ transmission. The combined HARQ transmissions may be processed for decoding and error correction such that the complete signal associated with the HARQ transmissions can be obtained.

In some implementations, the receiving device may be enabled to control whether to continue the HARQ process or revert to a non-HARQ retransmission scheme (such as an automatic repeat request (ARQ) protocol). Such switching may reduce feedback overhead and increase the flexibility for retransmissions by allowing devices to dynamically switch between ARQ and HARQ protocols during frame exchanges. Some implementations also may allow multiplexing of communications that employ ARQ with those that employ HARQ.

Some wireless communication devices (including both APs and STAs such as, for example, AP 102 and STAs 104 described with reference to FIG. 1) are capable of multi-link operation (MLO). In some implementations, MLO supports establishing multiple different communication links (such as a first link on the 2.4 GHz band, a second link on the 5 GHz band, and the third link on the 6 GHz band) between the STA 104 and the AP 102 and exchanging packets on one or more communications links concurrently and dynamically. Each communication link may support one or more sets of channels or logical entities. In some examples, each communication link associated with a given wireless communication device may be associated with a respective radio of the wireless communication device, which may include one or more transmit/receive (Tx/Rx) chains, include or be coupled with one or more physical antennas, or include signal processing components, among other components. An MLO-capable device may be referred to as a multi-link device (MLD). An MLD may include a single upper MAC layer, and can include, for example, three independent lower MAC layers and three associated independent PHY layers for respective links in the 2.4 GHz, 5 GHZ, and 6 GHz bands. This architecture may enable a single association process and security context. An AP MLD may include multiple APs each configured to communicate on a respective communication link with a respective one of multiple STAs 104 of a non-AP MLD (also referred to as a “STA MLD”). The STA MLD may communicate with the AP MLD over one or more of the multiple communication links at a given time. MLDs may independently contend for access on each of the communication links, which achieves latency reduction by enabling the MLD to transmit its packets on the first communication link that becomes available.

Another feature of MLO is Traffic Steering and QoS characterization, which achieves latency reduction and other QoS enhancements by mapping traffic flows having different latency or other requirements to different links. For example, traffic with low latency requirements can be mapped to wireless links operating in the 6 GHZ band and more latency-tolerant flows can be mapped to wireless links operating in the 2.4 GHz or 5 GHz bands.

One type of MLO is alternating multi-link, in which a MLD may listen to two different high performance channels at the same time. When an MLD has traffic to send, it may use the first channel with an access opportunity (such as TXOP). While the MLD may only use one channel to receive or transmit at a time, having access opportunities in two different channels provides low latency when networks are congested.

Another type of MLO is multi-link aggregation (MLA), where traffic associated with a single STA 104 is simultaneously transmitted across multiple communication links in parallel to maximize the utilization of available resources to achieve higher throughput. This is akin to carrier aggregation in the cellular space. That is, during at least some duration of time, transmissions or portions of transmissions may occur over two or more links in parallel at the same time. In some implementations, the parallel wireless communication links may support synchronized transmissions. In some other examples, or during some other durations of time, transmissions over the links may be parallel, but not be synchronized or concurrent. In some examples or durations of time, two or more of the links may be used for communications between the wireless communication devices in the same direction (such as all uplink or all downlink). In some other examples or durations of time, two or more of the links may be used for communications in different directions. For example, one or more links may support uplink communications and one or more links may support downlink communications. In such examples, at least one of the wireless communication devices operates in a full duplex mode. Generally, full duplex operation enables bi-directional communications where at least one of the wireless communication devices may transmit and receive at the same time.

MLA may be implemented in a number of ways. In some implementations, MLA may be packet-based. For packet-based aggregation, frames of a single traffic flow (such as all traffic associated with a given traffic identifier (TID)) may be sent concurrently across multiple communication links. In some other examples, MLA may be flow-based. For flow-based aggregation, each traffic flow (such as all traffic associated with a given TID) may be sent using a single one of multiple available communication links. As an example, a single STA MLD may access a web browser while streaming a video in parallel. The traffic associated with the web browser access may be communicated over a first communication link while the traffic associated with the video stream may be communicated over a second communication link in parallel (such that at least some of the data may be transmitted on the first channel concurrently with data transmitted on the second channel).

In some other examples, MLA may be implemented as a hybrid of flow-based and packet-based aggregation. For example, an MLD may employ flow-based aggregation in situations in which multiple traffic flows are created and may employ packet-based aggregation in other situations. The determination to switch among the MLA techniques or modes may additionally or alternatively be associated with other metrics (such as a time of day, traffic load within the network, or battery power for a wireless communication device, among other factors or considerations).

To support MLO techniques, an AP MLD and a STA MLD may exchange supported MLO capability information (such as supported aggregation type or supported frequency bands, among other information). In some implementations, the exchange of information may occur via a beacon signal, a probe request or probe response, an association request or an association response frame, a dedicated action frame, or an operating mode indicator (OMI), among other examples. In some implementations, an AP MLD may designate a given channel in a given band as an anchor channel (such as the channel on which it transmits beacons and other management frames). In such examples, the AP MLD also may transmit beacons (such as ones which may contain less information) on other channels for discovery purposes.

MLO techniques may provide multiple benefits to a wireless communication network 100. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the ON time of a modem, which may benefit a wireless communication device in terms of power consumption. Another benefit of MLO is the increased multiplexing opportunities in the case of a single BSS. For example, multi-link aggregation may increase the number of users per multiplexed transmission served by the multi-link AP MLD.

According to some aspects of the present disclosure, a first wireless device (such as an AP 102 or a STA 104) may receive a first signaling (e.g., OBSS transmission) indicating a first reservation of a first TXOP for a second wireless device (such as a STA 104 or an AP 102) on a first primary channel (such as an O-Primary Channel). The first primary channel may correspond to a first bandwidth including a first set of channels (e.g., 160 MHz bandwidth that includes channels P20, S20, S40, and S80, as shown in FIG. 2). A wireless device (such as the first wireless device, the second wireless device, or both) may reserve the first primary channel. The first wireless device may transmit or receive, via a second primary channel (such as a M-Primary channel) a second signaling indicating a second reservation of a second TXOP. The ending time of the second TXOP (such as when the first wireless device ends or terminates the second TXOP) may occur prior to the ending time of the first TXOP. Additionally, or alternatively, the ending time of the second TXOP may occur prior to a start of a TD associated with a communication event (such as one or more epochs). The communication event may be scheduled on the first subset of channels or a second subset of channels. Thus, the first wireless device may switch from the O-Primary channel to a M-Primary channel (which may be the original M-Primary channel associated with the first subset of channels or another M-Primary channel associated with the second subset of channels) and perform one or more functions on the M-Primary channel.

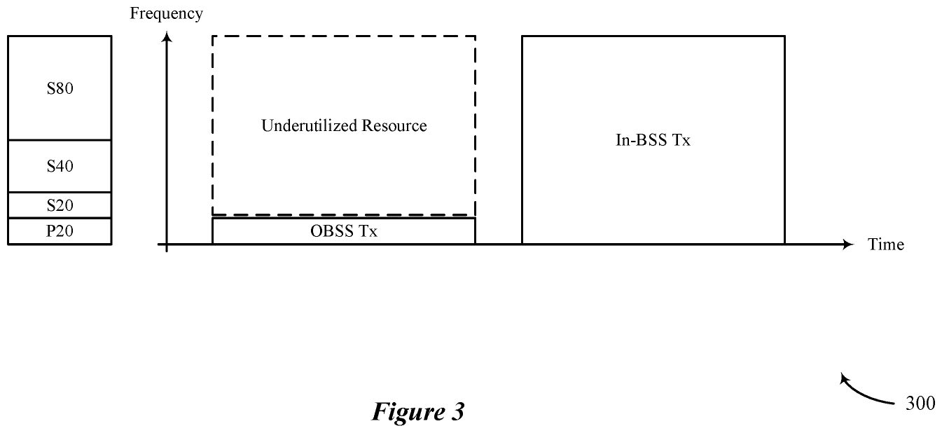

FIG. 3 shows an example of a resource diagram 300 that supports multi-primary channel access operation. The resource diagram 300 may implement or be implemented by aspects of the wireless communications network 100, as shown and described with reference to FIG. 1. For example, some aspects of the resource diagram 300 may be implemented by a wireless STA (such as one of the STAs 104 described with reference to FIG. 1), and other or the same aspects of the resource diagram 300 may be implemented by a wireless AP (such as the AP 102 described with reference to FIG. 1).

As described herein, some wireless networks may support multi-primary channel access. For example, some wireless networks may support bandwidths of up to 160 MHz or 320 MHz. Within these large bandwidths, one 20 MHz may be designated as a primary channel.

In some implementations, one or more wireless devices may contend for access to a first subchannel, such as a primary channel. Once the wireless device obtains access to (for example initiates communications within) that first subchannel, additional communications between the wireless device and another wireless device may occur across additional subchannels (such as in addition to the primary channel). That is, access to additional subchannels may be contingent on accessing the primary channel. However, if the first subchannel is occupied by other communications (such as by an OBSS, or by transmissions from another BSS STA), the wireless device may be unable to use the remainder of the operating bandwidth for communications. In other words, the primary channel, and thus the remaining bandwidth, may not be available for communication. The remainder of the operating bandwidth may be idle (such that the bandwidth remains unutilized), leading to communications between the wireless devices being delayed, and contributing to lower-throughput and longer latencies.

According to some aspects of the present disclosure, a first wireless device (such as an AP 102 or a STA 104) may receive a first signaling indicating a first reservation of a first TXOP for a second wireless device (such as a STA 104 or an AP 102) on a first primary channel (such as an M-Primary Channel). The first primary channel may correspond to a first bandwidth including a first subset of channels. A wireless device (such as the first wireless device, the second wireless device, or both) may reserve the first primary channel. The first wireless device may transmit or receive, via a second primary channel (such as a O-Primary channel) a second signaling indicating a second reservation of a second TXOP. The ending time of the second TXOP (such as when the first wireless device ends or terminates the second TXOP) may occur prior to the ending time of the first TXOP. Additionally, or alternatively, the ending time of the second TXOP may occur prior to a start of a TD associated with a communication event (such as one or more epochs). The communication event may be scheduled on the first subset of channels or a second subset of channels. Thus, the first wireless device may switch from the O-Primary channel to a M-Primary channel (which may be the original M-Primary channel associated with the first subset of channels or another M-Primary channel associated with the second subset of channels) and perform one or more functions on the M-Primary channel.

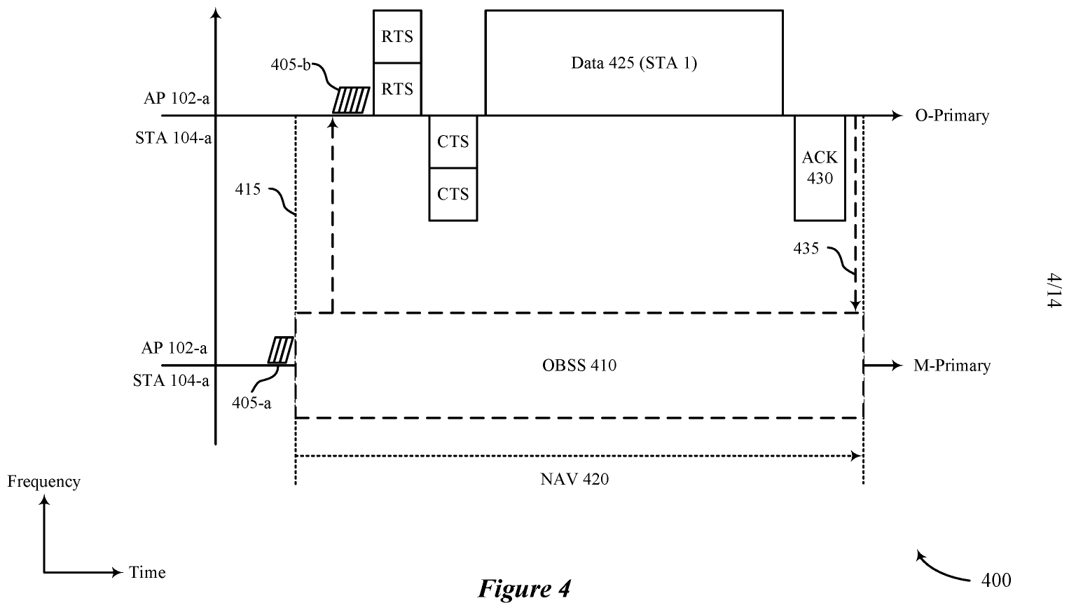

FIG. 4 shows an example of a resource diagram 400 that supports multi-primary channel access operation. The resource diagram 400 may implement or be implemented by aspects of the wireless communications network 100 or the resource diagram 300, as shown and described with reference to FIG. 1 and FIG. 3. For example, some aspects of the resource diagram 400 may be implemented by a wireless STA (such as one of the STAs 104 described with reference to FIG. 1), and other or the same aspects of the resource diagram 400 may be implemented by a wireless AP (such as the AP 102 described with reference to FIG. 1).

As described herein, some wireless networks may support multi-primary channel access. A device that supports ultra-high reliability (UHR) communications may be capable of monitoring additional 20 MHz channel(s) within an operating bandwidth. Monitoring may be sequential (such as when one 20 MHz channel is found busy, the UHR device may switch to a next 20 MHz channel) or parallel (such as the UHR device may monitor each 20 MHz channel simultaneously. As described herein, a primary channel may be referred to as a M-Primary channel. Additional subchannel(s) may be referred to as O-Primary channels. M-Primary functions as a primary channel, and may be used for beaconing, serving legacy clients, or the like. O-Primary enables opportunistic access on under-utilized subchannels. In some implementations, wireless devices may be unable to use M-Primary and O-Primary for simultaneous transmission and reception. In some other implementations, frequency separation can be used to support simultaneous Tx/Rx (such as using multiple receive chains).

As described herein, some wireless networks (such as the wireless network 100) may support EMLSR APs. A wireless device that supports UHR communications may be capable of monitoring multiple links that are configured for an associated AP. The monitoring may be sequential or parallel. As described herein, one of the channels may be a channel associated with a primary link of the AP. Additional channel(s) may be associated with non-primary links (or secondary links) of the APs. A primary link (also referred to herein as a M-Primary link) may be used for beaconing, serving legacy clients, etc. A non-primary link (also referred to herein as an O-Primary link) enables opportunistic access on under-utilized sub-channels/links. In some implementations, wireless devices may be unable to use primary and non-primary link(s) for simultaneous transmission and reception. In some other implementations, frequency separation can be used to support simultaneous Tx/Rx (such as using multiple receive chains). Although the concepts described hereinafter are explained in the context of multi-primary channel access, the described techniques are also applicable to EMLSR AP systems.

In some implementations, multi-primary access is enabled by an additional radio. In other implementations, however, these features can be enabled without an additional radio. If an additional radio is available, the use of such is not precluded. Thus, multi-primary features can be used for UHR with or without an additional radio. Some of the implementations described herein may assume there is no additional radio at the UHR device. To support multi-primary channel access without an additional radio, the transmitter and receiver may sequentially scan primary channels in the following manner: start with M-Primary; move to O-Primary-1 if M-Primary is busy; move to O-Primary-2 if O-Primary-1 is busy; and so on.

If there is a M-Primary and one O-Primary, the transmitter may perform CCA on M-Primary. If an OBSS PPDU is detected on M-Primary, the transmitter may record the NAV and switch to O-Primary. Accordingly, the transmitter may perform CCA on O-Primary. When RBO counts down, the transmitter may initiate frame exchanges with an ICF, which could be a multi-user request to send (MU-RTS), a buffer status report poll (BSRP) or some other frame, such as a bandwidth query report poll (BQRP) frame. On the other hand, the receiver may wait for a PPDU on M-Primary. If an OBSS PPDU is detected on M-Primary, the receiver may record the NAV and switch to O-Primary. Accordingly, the receiver may wait for a PPDU on O-Primary until M-Primary NAV is 0. Thereafter, the receiver may return to M-Primary before the NAV expires. If there is more than one O-Primary, the AP may specify the hopping order/sequence. The transmitter and receiver may switch to the next O-Primary in the sequence if the current primary is busy.

In some implementations, and with reference to FIG. 4, an AP 102-a may perform a channel contention procedure 405-a and determine that the M-Primary channel is occupied by another wireless device (such as by decoding a PPDU on the M-Primary channel and determining the M-Primary channel is occupied by an OBSS 410). The AP 102-a and STA 104-a may switch to the O-Primary channel at 415 until the M-Primary channel becomes available again. In some examples, the AP 102-a and STA 104-a may determine how long the M-Primary channel will be reserved (such as busy or unavailable) based on a network allocation vector (NAV) 420 provided by another wireless device. The NAV 420 may indicate an estimated duration of a transmit opportunity (TXOP) for which the other wireless device has access to the M-Primary channel.

In some implementations, the AP 102-a may perform a channel contention procedure 405-b. For example, the first wireless device may transmit a request to send frame (RTS) frame to confirm whether the STA 104-a has switched to the O-Primary channel. The STA 104-a may transmit a cleat to send (CTS) frame that confirms that the STA 104-a has switched to the O-Primary channel. The AP 102-a may transmit or receive one or more packets (such as a data 425, also referred herein as one or more PPDUs) to or from the STA 104-a via the O-Primary channel. The AP 102-a may receive an ACK 430 from the STA 104-a indicating that the STA 104-a successfully received the data 425. The AP 102-a and STA 104-a may switch back to the M-Primary channel at 435. The AP 102-a and STA 104-a may switch back to the M-Primary channel before the NAV 420 expires.

In some implementations, however, a predetermined or dynamic communication event (such as one or more epochs) may occur before the end of the TXOP (such as before the NAV 420 expires). Additionally, a wireless device (such as the AP 102-a or the STA 104-a may be expected to perform one or more functions (such as to transmit/receive a beacon, terminate a respective TXOP before a target wait time (TWT), transmit one or more group addressed frames after a delivery traffic indication message (DTIM) beacons) on a M-Primary link). However, the wireless device may be participating in frame exchanges (such as transmitting or receiving the data 425) on the O-Primary link during the communication event, due to the TXOP (such as the OBSS 410) on the M-Primary link.

In some implementations, the STA 104-a that has obtained a TXOP on O-Primary channel may end the TXOP at least a duration of TD before one or more epochs. In some examples, an epoch may be a TBTT of the AP on a same link or another link, a TWT SP on the same link or on another link, or both. In some examples, the TWT may be B-TWT, I-TWT, R-TWT, C-R-TWT, another TWT variant, or any combination thereof. In some examples, for epochs that correspond to another link, there may be specific relationship between a first link of the O-Primary channel and a second link on which the epoch is approaching. For example, the first and second links may form an NSTR pair, the links may be part of an EMLSR link set, the links may be part of an EMLMR link set, or any combination thereof. The STA 104-a may be an AP, a non-AP STA, or both. As discussed herein, end of a TXOP may mean that the STA 104-a gives up an acquired TXOP without transmitting anything.

In some examples, an epoch may not pre-determined but instead may be dynamic. For example, an epoch may correspond to certain activity on a same link or another link (e.g., that cannot be predicted ahead of time). In some examples, the STA 104-a may give up an acquired TXOP if it determines its transmission may cause NSTR interference on another link of an NSTR link pair.

Additionally, the STA 104-a tries to initiate an O-primary TXOP when an epoch is approaching by transmitting a frame (such as a short frame, an ICF), a peer STA may take preventative actions. In some examples, the preventative actions may be refusing to respond to the frame, or responding to the frame indicating refusal to participate in subsequent frames (such that the peer STA responds with a frame that has Power Management subfield set to 1 to indicate that it is entering a power save mode or that has the A-Control field set to a specific value), or indicating to a peer STA to terminate TXOP by stopping the transmission of further frames, or any combination thereof.

In some implementations, a first wireless device (such as the AP 102-a or a STA 104-a) may receive a first signaling indicating a first reservation of a first TXOP for a second wireless device (such as a STA 104 or an AP 102) on a first primary channel (such as an M-Primary Channel). The first primary channel may correspond to a first bandwidth including a first subset of channels. A wireless device (such as the first wireless device, the second wireless device, or both) may reserve the first primary channel. The first wireless device may transmit or receive, via a second primary channel (such as a O-Primary channel) a second signaling indicating a second reservation of a second TXOP. The signaling may indication a duration of time for the second TXOP. The ending time of the second TXOP (such as when the first wireless device ends or terminates the second TXOP) may occur prior to the ending time of the first TXOP. Additionally, or alternatively, the ending time of the second TXOP may occur prior to a start of a TD associated with a communication event (such as one or more epochs). The communication event may be scheduled on the first subset of channels or a second subset of channels. Thus, the first wireless device may switch from the O-Primary channel to a M-Primary channel (which may be the original M-Primary channel associated with the first subset of channels or another M-Primary channel associated with the second subset of channels) and perform one or more functions on the M-Primary channel or enable the responding device (such as the TXOP responder) to perform one or more functions on the M-Primary channel.

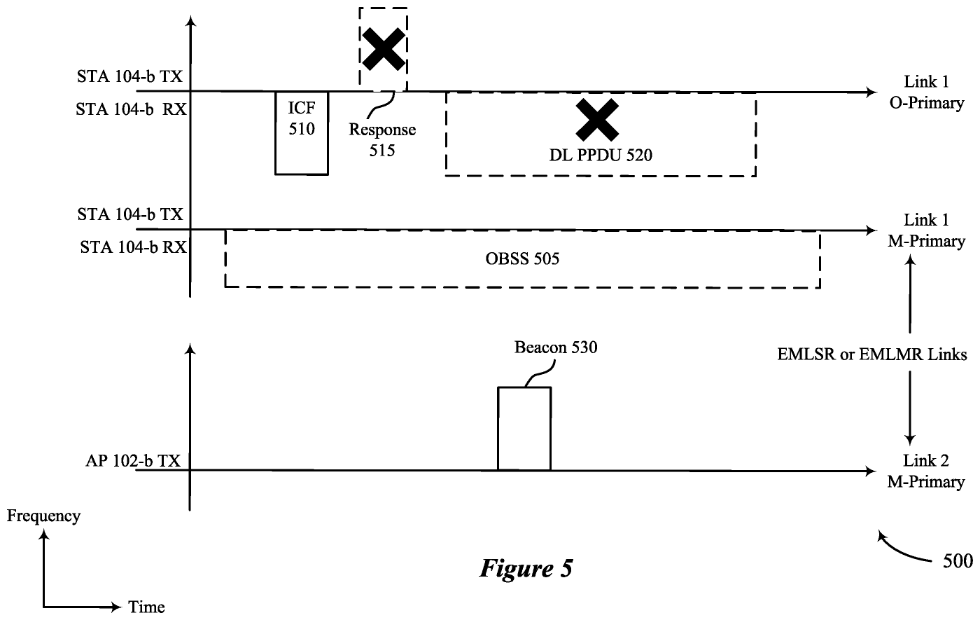

FIG. 5 shows an example of a resource diagram 500 that supports multi-primary channel access operation. The resource diagram 500 may implement or be implemented by aspects of the wireless communications network 100, the resource diagram 300, or the resource diagram 400, as shown and described with reference to FIG. 1, FIG. 3, and FIG. 4. For example, some aspects of the resource diagram 500 may be implemented by a wireless STA 104-b (such as one of the STAs 104 described with reference to FIG. 1), and other or the same aspects of the resource diagram 400 may be implemented by a wireless AP 102-b (such as the AP 102 described with reference to FIG. 1).

In some implementations, an STA 104-b (such as a non-AP STA) may receive an OBSS 505 (such as a third signaling) indicating a reservation (such as a third reservation) of a TXOP (such as a duration of the OBSS 505) on the M-Primary channel of Link 1 (such as a first primary channel of a first plurality of channels). The STA 104-b may switch to an O-Primary channel of Link 1. The STA 104-b may receive, via the O-Primary channel (such as a second primary channel) an ICF 510. The ICF 510 may indicate a third reservation of a third TXOP on the O-primary channel of Link 1, for receiving the response 515 and subsequent reception of one or more DL PPDUs 520. However, a communication event (such as a beacon 530) may be scheduled to occur during the duration of the OBSS 505. In some implementations, Link 1 and Link 2 may be EMLSR links. In some other implementations, Link 1 and Link 2 may be EMLMR links.

In some implementations, the AP 102-b may expect to receive a response 515 (such as one or more packets) to the ICF 510 from the STA 104-b. In some implementations, the STA 104-b may refrain from transmitting a response 515 to the ICF 510. Additionally, or alternatively, the AP 102-a may refrain from transmitting a DL PPDU 520 to the STA 104-b. If the STA 104-b transmits the response 515, the AP 102-b may transmit the DL PPDU 520. However, the DL PPDU 520 may overlap (such as in time resources) with the TBTT (such as the beacon 530) on Link 2. In other words, the STA 104-b may refrain from transmitting the response 515 based on the beacon 530 (such as an epoch) occurring during the duration of the OBSS 505. Thus, the STA 104-b may have sufficient time to switch to Link 2 and receive the beacon 530 on the M-Primary channel (such as a third primary channel) on Link 2.

In some implementations, the STA 104-b may transmit a response 515 to the ICF 510 (such as response to the second singling). For example, the response 515 may indicate to the AP 102-b, or another STA (such as a peer STA), a refusal to communicate during at least a portion of the OBSS 505 (such as the third TXOP). For instance, the STA 104-b may transmit the response 515 including a frame (such as with a power management (PM) field of the MAC header in a frame set to 1 or with an A-Control field set to a specific value). The AP 102-a and the STA may refrain from communicating with the STA 104-b in subsequent frames. Thus, the STA 104-b may have sufficient time to switch to Link 2 and receive the beacon 530 on the M-Primary channel of Link 2.

In some implementations, the STA 104-b may transmit a response 515 (such as one or more packets) to the ICF 510. For example, the response 515 may indicate an instruction to the AP 102-b, or to another STA (such as a peer STA), to refrain from transmitting (for example to stop the transmission of further frames) during at least a portion of the OBSS 505 (such as the third TXOP). The AP 102-b, or the other STA, may receive the response 515 and refrain from transmitting the DL PPDU 520 during the third TXOP. Thus, the STA 104-b may have sufficient time to switch to Link 2 and receive the beacon 530 on the M-Primary channel on Link 2.

In some implementations the AP 102-b may initiate a TXOP on the M-Primary channel on one of the one or more EMLSR links with an ICF. For example, the ICF may be an MU-RTS or a BSRP trigger frame. Other APs or other STAs on one of the EMLSR links may not initiate a TXOP on their respective EMLSR links. In multi-primary operations, EMLSR may be extended to one or more O-Primary channels. For instance, the AP 102-b and the STA 104-b may be exchanging frames on the O-Primary channel of Link 1. In these instances, the AP 102-b or the STA 104-b may not initiate a frame exchange on the M-Primary channel of Link 2. Additionally, or alternatively, the AP 102-b or the STA 104-b may not initiate a frame exchange on the O-Primary channel of Link 2. In some other instances, the AP 102-b and the STA 104-b may be exchanging frames on Link 2. In these instances, the AP 102-b or the STA 104-b may not initiate a frame exchange on the M-Primary channel or the O-Primary channel of Link 1. Although described as being EMLSR links, the one or more links may instead be EMLMR links and comply with similar conditions.

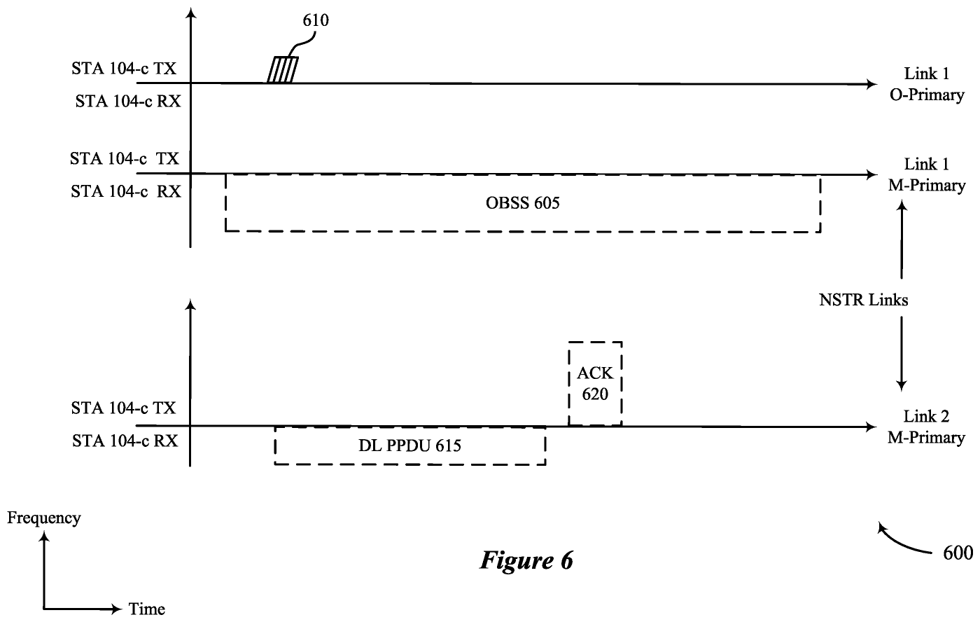

FIG. 6 shows an example of a resource diagram 600 that supports multi-primary channel access operation. The resource diagram 600 may implement or be implemented by aspects of the wireless communications network 100 and the resource diagrams 300-500, as shown and described with reference to FIG. 1 and FIGS. 3-5. For example, some aspects of the resource diagram 500 may be implemented by a wireless STA 104-c (such as one of the STAs 104 described with reference to FIG. 1), and other or the same aspects of the resource diagram 500 may be implemented by a wireless AP (such as the AP 102 described with reference to FIG. 1).

In some implementations, a communication event (such as a second communication event) may be dynamic. For example, the STA 104-c may not know that a communication event will occur prior to the start of an OBSS 605. That is, the communication event may not be pre-determined. The communication event (such as an epoch) may correspond to a certain activity on Link 1 (e.g., dynamic PPDU reception on another link, link 2). Additionally, or alternatively, the communication event may correspond to a certain activity on Link 2. The certain activity may not be predicted ahead of time. Thus, the STA 104-c may give up an acquired TXOP (for example end the acquired TXOP) if a transmission during the TXOP may cause NSTR interference on another link of an NSTR link pair.

In some implementations, an STA 104-c (such as a non-AP STA) may receive an OBSS 605 (such as a third signaling) indicating a reservation (such as a third reservation) of a third TXOP (such as a duration of the OBSS 605) on the M-Primary channel of Link 1 (such as a first primary channel of a first plurality of channels). The STA 104-c may switch communications to an O-Primary channel of Link 1. The STA 104-c may perform a CCA 610 on O-Primary. For example, an RBO may count down. If the CCA 610 is successful, the STA 104-c may acquire a TXOP. However, a dynamic communication event (such as a second communication event) may occur during the duration of this TXOP (such as the duration of the OBSS 605). Additionally, or alternatively, an overlapping communication (such as a DL PPDU 615 and/or an ACK 620) may occur during the duration of this TXOP. In some implementations, Link 1 and Link 2 may form an NSTR link pair.

In some implementations, the STA 104-c may determine that a transmission on Link 1 may cause NSTR interference on another link of an NSTR link pair (such as Link 2). Thus, the STA 104-c may refrain from transmitting an ICF or other transmissions on Link 1 in order to receive a DL PPDU 615. As such, the STA 104-c may give up an acquired TXOP on the M-Primary channel on Link 1 to present NSTR interference on another link, Link 2. Additionally, or alternatively, the STA 104-c may transmit an ACK 620 in response to the DL PPDU 615.

In some implementations, NSTR transmissions (such as PPDUs) may occur across multiple links. The start and end alignment of PPDU transmissions may be aligned across NSTR links. For example, uplink PPDU transmission occurs simultaneously on different links, and the uplink PPDU transmission starts at the same starting time, and ends at the same ending time, on the different links. For example, a STA may desire to transmit on links 1 and 2, and may contend to obtain channel access on an O-Primary channel of link 1 and on an M-Primary channel of link 2. The STA may start transmitting one or more uplink PPDU transmissions on the O-Primary channel of link 1 may start at the same time as transmitting one or more uplink PPDU transmissions on an M-Primary channel of link 2. The STA may also end transmission of the one or more uplink PPDU transmissions on the O-Primary channel of link 1 at the same time as ending transmission of the one or more uplink PPDU transmissions on an M-Primary channel of link 2. In multi-primary operation, the starting and ending of a synced PPDU transmission may be applied across the M-Primary channel of Link 2 and the O-Primary channel of Link 1, the M-Primary channel of Link 1 and the O-Primary channel of Link 2, or the O-Primary channel of Link 1 and the O-Primary channel of Link 2.

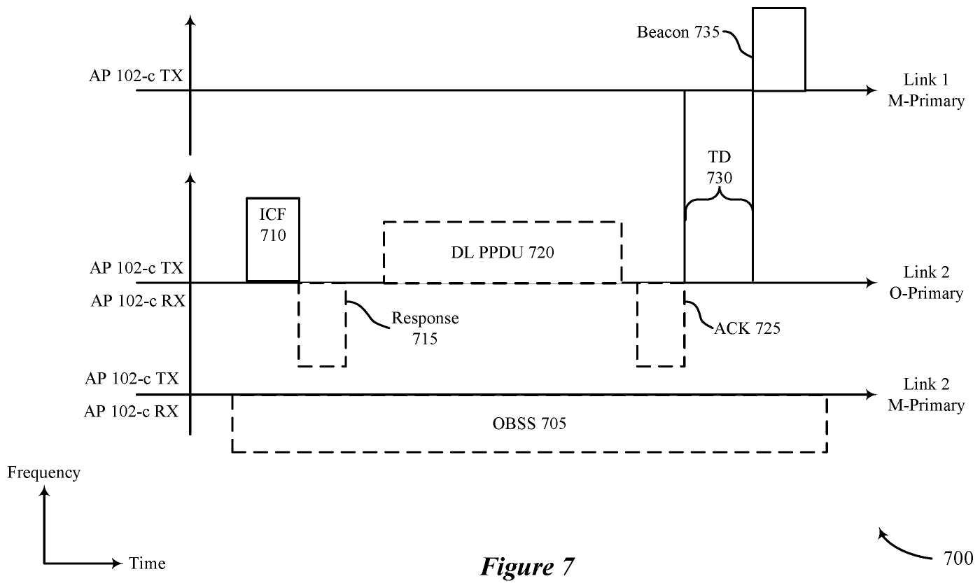

FIG. 7 shows an example of a resource diagram 700 that supports multi-primary channel access operation. The resource diagram 700 may implement or be implemented by aspects of the wireless communications network 100 and the resource diagrams 300-600, as shown and described with reference to FIG. 1 and FIGS. 3-6. For example, some aspects of the resource diagram 600 may be implemented by a wireless STA (such as one of the STAs 104 described with reference to FIG. 1), and other or the same aspects of the resource diagram 600 may be implemented by a wireless AP 102-c (such as the AP 102 described with reference to FIG. 1).

In some implementations, an AP 102-c (such as a first wireless device) may receive an OBSS 705 (such as a first signaling) indicating a reservation (such as a first reservation) of a first TXOP (such as a duration of the OBSS 705) on the M-Primary channel of Link 1 (such as a first primary channel of a first bandwidth comprising a first plurality of channels). The OBSS 705 may indicate an ending time of the first TXOP. The AP 102-c may determine that the M-Primary channel of Link 1 is busy and may switch communications (such as switching the main radio) to an O-Primary channel of Link 1.

In some implementations, the AP 102-c may transmit an ICF 710 (such as a second signaling). For example, the AP 102-c may transmit the ICF 710 to an STA via the O-Primary channel (such as a second primary channel) of Link 1. The ICF 710 may indicate a second reservation of a second TXOP. The ending time of the second TXOP (such as when the AP 102-c ends or terminates the second TXOP) may occur prior to the ending time of the OBSS 705. Additionally, or alternatively, the ending time of the second TXOP may occur prior to a start of a TD 730. The TD 730 may be associated with a beacon 735 (such as a communication event). The beacon 735 may be scheduled on a M-Primary channel (such as a third primary channel) of Link 1 (such as a second plurality of channels of a second bandwidth). Link 1 (such as a primary link) and Link 2 (such as a non-primary link) may form an EMLSR link set. That is, the AP 102-c may be an EMLSR AP.

In some implementations, the AP 102-c may transmit or receive one or more packets during the second TXOP. For example, the AP 102-c may receive a response 715 to the ICF 710. The AP 102-c may transmit a DL PPDU 720. Additionally, or alternatively, the AP 102-c may receive an ACK 725 in response to the DL PPDU 720. The one or more packets may be communicated (such as transmitted or received) during the second TXOP and prior to the start of the TD 730 (such as in accordance with the second signaling). As such, the AP 102-c on nonprimary link of an EMLSR AP may end the TXOP on O-Primary before TBTT of the primary link, Link 1.

In some implementations, a TD 730 may be associated with switching from the O-Primary channel of Link 2 (such as the second primary channel) to a M-Primary channel of Link 1 (such as the third primary channel). This TD 730 may be a cross link TD that is different from the TD associated with switching from an O-Primary channel to a M-Primary channel, the TD associated with switching from a first link to a second link, or both. The AP 102-c may switch to the primary channel on which the communication event is scheduled on. Additionally, or alternatively, the TD 730 may be associated with an EMLSR TD or an EMLMR TD. The TD 730 may be indicated in one or more management frames (such as beacons, probe requests, probe responses, associated requests, associated responses). The one or more management frames may be separate from the delay associated with switching from one primary channel to another and link switch delays. In some other instances, the TD 730 may be zero.

In some implementations, the AP 102-c may perform one or more functions at a communication event (such as one or more epochs). For example, the AP 102-c may transmit the beacon 735. Examples of a communication event may include, but are not limited to, a TBTT (such as a target beacon transmission beam scheduled on Link 1 or Link 2) and a TWT service period (SP) (scheduled on Link 1 or Link 2), where an AP affiliated with an EMLSR AP ends TXOP on O-Primary of Link 2 (nonprimary link) so that a Main Radio of the AP may transmit a beacon during the TBTT of primary link, link 1. For instance, the TWT may be a broadcast TWT (B-TWT), an individual TWT (I-TWT), a restricted TWT (R-TWT), or a coordinated restricted TWT (C-R-TWT). The TWT may be associated with the M-Primary channel (such as the first primary channel) and may apply to the O-Primary channel (such as the second primary channel).

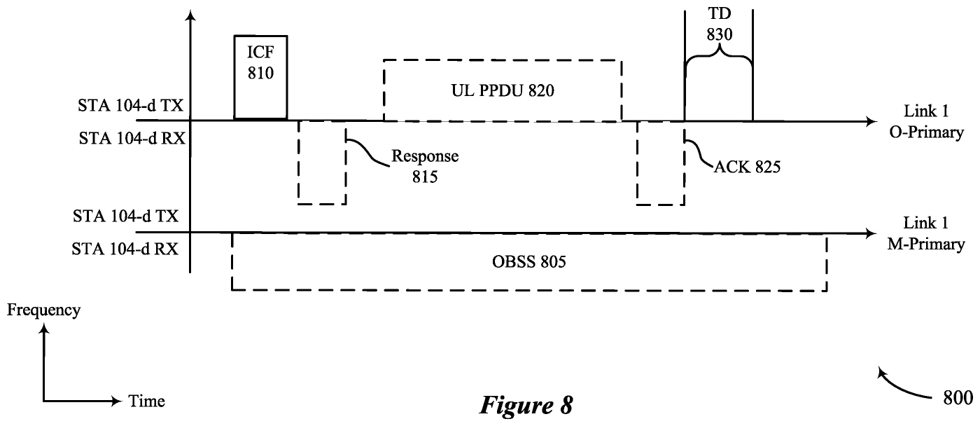

FIG. 8 shows an example of a resource diagram 800 that supports multi-primary channel access operation. The resource diagram 800 may implement or be implemented by aspects of the wireless communications network 100 and the resource diagrams 300-700, as shown and described with reference to FIG. 1 and FIGS. 3-7. For example, some aspects of the resource diagram 800 may be implemented by a STA 104-d (such as one of the STAs 104 described with reference to FIG. 1), and other or the same aspects of the resource diagram 800 may be implemented by a wireless AP (such as the AP 102 described with reference to FIG. 1).

In some implementations, a STA 104-d (such as a first wireless device) may receive an OBSS 805 (such as a first signaling) indicating a reservation (such as a first reservation) of a first TXOP (such as a duration of the OBSS 805) on the M-Primary channel of Link 1 (such as a first primary channel of a first bandwidth comprising a first plurality of channels). The OBSS 805 may indicate an ending time of the first TXOP. The STA 104-d may determine that the M-Primary channel of Link 1 is busy and may switch communications (such as switching the main radio) to an O-Primary channel of Link 1.

In some implementations, the STA 104-d may transmit an ICF 810 (such as a second signaling). For example, the STA 104-d may transmit the ICF 810 to an AP, or another STA (such as a peer STA), via the O-Primary channel (such as a second primary channel) of Link 1. The ICF 810 may indicate a second reservation of a second TXOP. The ending time of the second TXOP (such as when the STA 104-d ends or terminates the second TXOP) may occur prior to the ending time of the OBSS 805. Additionally, or alternatively, the ending time of the second TXOP may occur prior to a start of a TD 830. The TD 830 may be associated with a communication event. The communication event may be scheduled on the M-Primary channel (such as the first primary channel) of Link 1. The STA 104-d may be a non-AP MLD. The STA 104-d may be associated with an EMLSR AP MLD. In some instances, the STA 104-d of the non-AP MLD may be operating on a non-primary link.

In some implementations, the STA 104-d may transmit or receive one or more packets during the second TXOP. For example, the STA 104-d may receive a response 815 to the ICF 810. The STA 104-d may transmit an uplink (UL) PPDU 820. Additionally, or alternatively, the STA 104-d may receive an ACK 825 in response to the UL PPDU 820. The one or more packets may be communicated (such as transmitted or received) during the second TXOP and prior to the start of the TD 830 (such as in accordance with the second signaling). As such, the STA 104-d on a nonprimary link of an EMLSR AP may end the TXOP on O-Primary before TBTT of the primary link.

In some implementations, a TD 830 may be associated with switching from the O-Primary channel of Link 1 (such as the second primary channel) to the M-Primary channel of Link 1 (such as the first primary channel) or a M-Primary channel of another link (such as a third primary channel). The STA 104-d may switch to the primary channel in which the communication event is scheduled on. The TD 830 may be a TBTT on the M-Primary channel. In an example, the STA of a non-AP MLD associated with an EMLSR AP MLD may end a TXOP on O-Primary of Link 1 (primary link) so that a Main Radio of EMLSR AP MLD may transmit a Beacon during the TBTT of primary link. In some instances, an in-BSS STA may honor the TBTT on the M-Primary channel. As the OBSS STA is occupying the M-Primary channel, ending the second TXOP at the TBTT may not allow an AP to transmit exactly at the TBTT. However, the AP may still be available to transmit a beacon after an end of (such as immediately after) an OBSS PPDU.

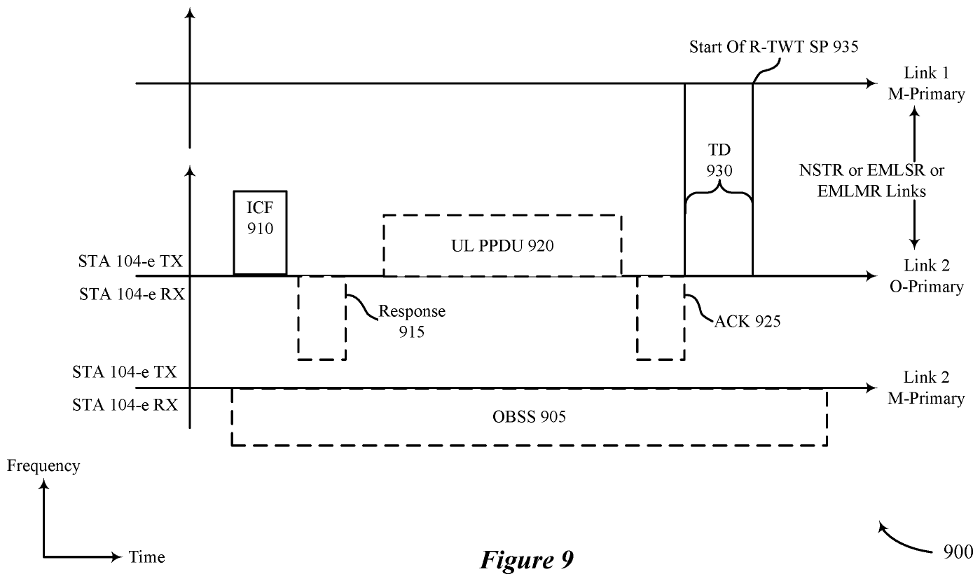

FIG. 9 shows an example of a resource diagram 900 that supports multi-primary channel access operation. The resource diagram 900 may implement or be implemented by aspects of the wireless communications network 100 and the resource diagrams 300-800, as shown and described with reference to FIG. 1 and FIGS. 3-8. For example, some aspects of the resource diagram 800 may be implemented by a STA 104-e (such as one of the STAs 104 described with reference to FIG. 1), and other or the same aspects of the resource diagram 900 may be implemented by a wireless AP (such as the AP 102 described with reference to FIG. 1).

In some implementations, a STA 104-e (such as a first wireless device) may receive an OBSS 905 (such as a first signaling) indicating a reservation (such as a first reservation) of a first TXOP (such as a duration of the OBSS 905) on the M-Primary channel of Link 2. The OBSS 905 may indicate an ending time of the first TXOP. The STA 104-e may determine that the M-Primary channel of Link 2 is busy and may switch communications (such as switching the main radio) to an O-Primary channel of Link 2.

In some implementations, the STA 104-e may transmit an ICF 910 (such as a second signaling). For example, the STA 104-e may transmit the ICF 910 to an AP, or another STA (such as a peer STA), via the O-Primary channel (such as a second primary channel) of Link 2. The ICF 910 may indicate a second reservation of a second TXOP. The ending time of the second TXOP (such as when the STA 104-e ends or terminates the second TXOP) may occur prior to the ending time of the OBSS 905. Additionally, or alternatively, the ending time of the second TXOP may occur prior to a start of a TD 930. The TD 930 may be associated with a start of a R-TWT SP 935 (such as a communication event). The communication event may be scheduled on the M-Primary channel of Link 1 (such as another link). The STA 104-e may be a non-AP MLD. In some instances, Link 1 and Link 2 may form NSTR links, or EMLSR links, or EMLMR links.

In some implementations, the STA 104-e may transmit or receive one or more packets during the second TXOP. For example, the STA 104-e may receive a response 915 to the ICF 910. The STA 104-e may transmit an UL PPDU 920. Additionally, or alternatively, the STA 104-e may receive an ACK 925 in response to the UL PPDU 920. The one or more packets may be communicated (such as transmitted or received) during the second TXOP and prior to the start of the TD 930 (such as in accordance with the second signaling). As such, the STA 104-e may end the TXOP on O-Primary before R-TWT SP begins on another link.

In some implementations, a TD 930 may be associated with switching from the O-Primary channel of Link 2 (such as the second primary channel) to a M-Primary channel of Link 1 (such as a third primary channel). The STA 104-e may switch to the primary channel in which the communication event (such as the start of the R-TWT SP 935) is scheduled on. Thus, the STA 104-e may participate in the R-TWT SP 935 on the M-Primary channel of Link 1. For example, the STA 104-e of a non-AP MLD may end the TXOP on O-Primary link of link 2 so that it can transition its Main Radio to link 2 and participate in R-TWT SP, wherein Link 1 and 2 may be NSTR links, EMLSR links, EMLMR links, or any combination thereof. In some instances, the R-TWT SP 935 may be a C-R-TWT SP. For instance, the R-TWT SP 935 may be a C-R-TWT SP if an AP is the owner of the C-R-TWT SP or if the AP intends to contend during the C-R-TWT SP, where the C-R-TWT SP is owned by another coordinating AP.

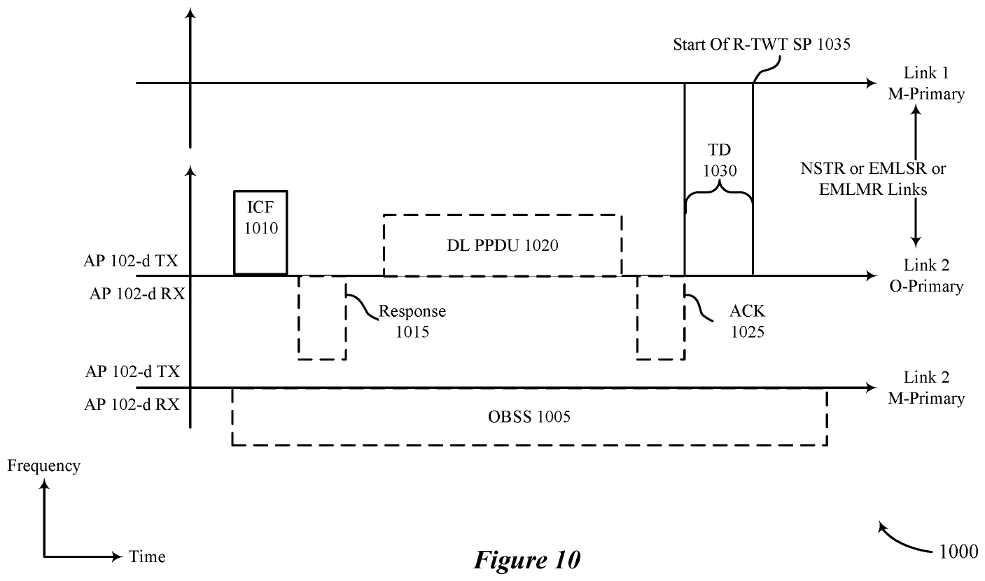

FIG. 10 shows an example of a resource diagram 1000 that supports multi-primary channel access operation. The resource diagram 1000 may implement or be implemented by aspects of the wireless communications network 100 and the resource diagrams 300-900, as shown and described with reference to FIG. 1 and FIGS. 3-9. For example, some aspects of the resource diagram 1000 may be implemented by a STA (such as one of the STAs 104 described with reference to FIG. 1), and other or the same aspects of the resource diagram 1000 may be implemented by an AP 102-d (such as the AP 102 described with reference to FIG. 1).

In some implementations, an AP 102-d (such as a first wireless device) may receive an OBSS 1005 (such as a first signaling) indicating a reservation (such as a first reservation) of a first TXOP (such as a duration of the OBSS 1005) on the M-Primary channel of Link 2. The OBSS 1005 may indicate an ending time of the first TXOP. The AP 102-d may determine that the M-Primary channel of Link 2 is busy and may switch communications (such as switching the main radio) to an O-Primary channel of Link 2.

In some implementations, the AP 102-d may transmit an ICF 1010 (such as a second signaling). For example, the AP 102-d may transmit the ICF 1010 to an STA via the O-Primary channel (such as a second primary channel) of Link 2. The ICF 1010 may indicate a second reservation of a second TXOP. The ending time of the second TXOP (such as when the AP 102-d ends or terminates the second TXOP) may occur prior to the ending time of the OBSS 1005. Additionally, or alternatively, the ending time of the second TXOP may occur prior to a start of a TD 1030. The TD 1030 may be associated with a start of a R-TWT SP 1035 (such as a communication event). The communication event may be scheduled on the M-Primary channel of Link 1 (such as another link). The AP 102-d may be an AP MLD. In some instances, Link 1 and Link 2 may form NSTR links, or EMLSR links, or EMLMR links.

In some implementations, the AP 102-d may transmit or receive one or more packets during the second TXOP. For example, the AP 102-d may receive a response 1015 to the ICF 1010. The AP 102-d may transmit an DL PPDU 1020. Additionally, or alternatively, the AP 102-d may receive an ACK 1025 in response to the DL PPDU 1020. The one or more packets may be communicated (such as transmitted or received) during the second TXOP and prior to the start of the TD 1030 (such as in accordance with the second signaling). As such, the AP 102-d may end the TXOP on O-Primary before R-TWT SP on another link.

In some implementations, a TD 1030 may be associated with switching from the O-Primary channel of Link 2 (such as the second primary channel) to a M-Primary channel of Link 1 (such as a third primary channel). The AP 102-d may switch to the primary channel in which the communication event (such as the start of the R-TWT SP 1035) is scheduled on. Thus, the AP 102-d may participate in the R-TWT SP 1035 on the M-Primary channel of Link 1. In some instances, the AP 102-d of an AP MLD may end the TXOP on O-Primary link of link 2 so that the non-AP MLD may transition its Main Radio to link 2 and participate in R-TWT SP. Links 1 and 2 may be NSTR links, EMLSR links, EMLMR links, or any combination thereof. In some instances, the R-TWT SP 1035 may be a C-R-TWT SP. For instance, the R-TWT SP 1035 may be a C-R-TWT SP if an AP is the owner of the C-R-TWT SP or if the AP intends to contend during the C-R-TWT SP, where the C-R-TWT SP is owned by another coordinating AP.

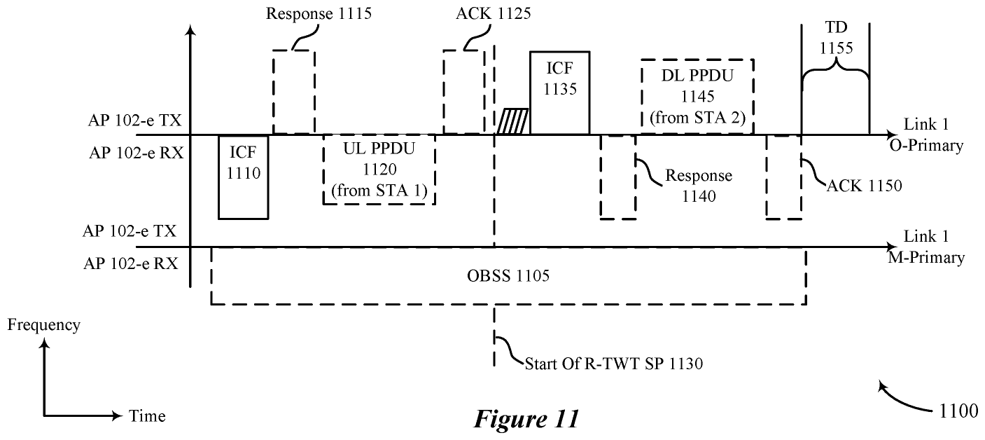

FIG. 11 shows an example of a resource diagram 1100 that supports multi-primary channel access operation. The resource diagram 1100 may implement or be implemented by aspects of the wireless communications network 100 and the resource diagrams 300-1000, as shown and described with reference to FIG. 1 and FIGS. 3-10. For example, some aspects of the resource diagram 1100 may be implemented by a STA (such as one of the STAs 104 described with reference to FIG. 1), and other or the same aspects of the resource diagram 1100 may be implemented by an AP 102-e (such as the AP 102 described with reference to FIG. 1).

In some implementations, an AP 102-e (such as a first wireless device) may receive an OBSS 1105 (such as a first signaling) indicating a reservation (such as a first reservation) of a first TXOP (such as a duration of the OBSS 1105) on the M-Primary channel of Link 1. The OBSS 1105 may indicate an ending time of the first TXOP. The AP 102-e may determine that the M-Primary channel of Link 1 is busy and may switch communications (such as switching the main radio) to an O-Primary channel of Link 1. The AP 102-e may receive the OBSS 1105 from a STA that may not support R-TWT.

In some implementations, the AP 102-e may receive an ICF 1110 (such as a second signaling). For example, the AP 102-e may receive the ICF 1110 from an STA via the O-Primary channel (such as a second primary channel) of Link 1. The ICF 1110 may indicate a second reservation of a second TXOP. The ending time of the second TXOP (such as when the AP 102-e ends or terminates the second TXOP) may occur prior to the ending time of the OBSS 1105. Additionally, or alternatively, the ending time of the second TXOP may occur prior to a start of a R-TWT SP 1130. The R-TWT SP 1130 may be scheduled on the same link (such as Link 1).

In some implementations, the AP 102-e may transmit or receive one or more packets during the second TXOP. For example, the AP 102-e may transmit a response 1115 to the ICF 1110. The AP 102-e may receive an UL PPDU 1120 from a first STA. Additionally, or alternatively, the AP 102-e may transmit an ACK 1125 in response to the UL PPDU 1120. The one or more packets may be communicated (such as transmitted or received) during the second TXOP and prior to the start of the R-TWT SP 1130 (such as in accordance with the second signaling). As such, the first STA may end the TXOP on O-Primary of link 1 prior to the start of the R-TWT SP 1130.

In some implementations, the TD may be 0. For instance, the TD may be 0 since the R-TWT SP 1130 is on the same link (Link 1). Thus, the AP 102-e may perform a channel access procedure after the start of the R-TWT SP 1130. If the AP 102-e obtains access to the O-Primary channel of Link 1, the AP 102-e may communicate one or more packets on the O-Primary channel. For example, the AP 102-e may transmit an ICF 1135. The AP 102-e may receive a response 1140 to the ICF 1135. The AP 102-e may transmit a DL PPDU 1145 to a second STA. The AP 102-e may receive an ACK 1150 in response to the DL PPDU 1145. The one or more packets may be communicated before the start of a TD 1155.

In some implementations, the AP 102-e may transmit an ACK 1125 including an indication to stop the second TXOP. That is, the AP 102-e may transmit the ACK 1125 to an STA (such as a peer STA) that indicates to stop the second TXOP on the O-Primary channel of Link 1 before the start of the R-TWT SP 1130. Thus, the STA may refrain from transmitting (such as stop sending) one or more packets (such as PPDUs) at some time before, or at, the start of the R-TWT SP 1130 in response to the ACK 1125. In some other implementations, the AP 102-e may receive signaling (such as a response or an ACK), from an STA, indicating to the AP 102-e to stop the second TXOP (such as if the AP 102-e obtained the second TXOP), In some instances, the R-TWT SP 1130 may be a C-R-TWT SP or any other type of TWT.

In some implementations, the R-TWT SP 1130, or a C-R-TWT SP, may extend to multiple primaries. Additionally, one or more rules (such as rules for R-TWT or other TWT types) may only apply to M-Primary. However, an O-Primary transmission on the same channel may fail to honor the R-TWT SP 1130 boundaries. Thus, the O-Primary transmission may disrupt a R-TWT limit. Additionally, or alternatively, the O-Primary transmission may limit the bandwidth of C-R-TWT operations.

In some implementations, any R-TWT SPs 1130, C-R-TWT SPs, or both, on a M-Primary channel may apply (such as automatically apply) to an O-Primary channel. In some other implementations, the AP 102-e may transmit an indication of whether R-TWT SPs, C-R-TWT SPs, or both, on a M-Primary channel apply to an O-Primary channel. For example, if there is more than one O-Primary channel, the AP 102-e may transmit an indication (such as a bitmap) that indicates on which O-Primary channels the SPs apply to. Additionally, or alternatively, the AP 102-e may negotiate whether a R-TWT SP 1130 applies to an O-Primary channel with an STA (such as negotiation between two peers). Although described as R-TWT SPs 1130, the SPs also may be C-R-TWT SPs or any other type of TWT.

In some implementations, each O-Primary channel may have an independent setup of R-TWT SPs 1130, C-R-TWT SPs, or both. That is, a TWT setup may be done on a per primary basis. In these instances, a rule for a first primary channel may not apply to other primary channels. In other words, if an R-TWT setup is for an O-Primary channel on Link 1, this setup (such as the corresponding rules) may not apply to an O-Primary channel on Link 2 or a M-Primary channel (such as on only link). In some other instances, a TWT may apply to multiple primary channels. For example, an AP 102-e may transmit a message including a bitmap that indicates which one or more O-Primary channels the TWT applies to. The AP 102-e may indicate which O-Primary channels the TWT applies to if the AP 102-e is experiencing periodic narrowband OBSS transmissions. For instance, if the AP 102-e (such as a legacy AP) has a setup for a TWT SP on a M-Primary channel which occupies only part of a bandwidth, the AP may 102-e may setup an SP on one or more O-Primary channels. Additionally, or alternatively, O-Primary-1 rules (such as rules for an O-Primary channel on Link 1) may not apply to an O-Primary-2 (such as an O-Primary channel on Link 2). The O-Primary-1 rules may apply to a M-Primary channel (such as a M-Primary channel on Link 1). Although described as R-TWT SPs 1130, the SPs also may be C-R-TWT SPs or any other type of TWT.

In some implementations, a R-TWT SP 1130 may only apply within a BSS. For example, the AP 102-e may set up the R-TWT SP 1130. STAs associated with the AP 102-e may honor the SP limit (such as ending their TXOPs before the start time of the SP, so that the AP can contend right at the start of the SP and transmit to low latency STAs). However, other APs in the vicinity of the AP 102-e may not honor the SPs, and as a result, a second AP or STAs associated with the second AP might continue their TXOPs while the R-TWT SP 1130 of the AP 102-e starts. This may delay the AP 102-e to service low latency STAs and affect their performance. In some other implementations, in C-R-TWT operation, APs may now honor each other's SPs and announce each other's SPs in their respective beacons. For instance, an AP may announce the SP of a second AP in its respective beacons, and the second AP may announce the first AP's SPs in its respective beacons (such that a first AP and a second AP already announce their own SPs in their own respective beacons). Thus, the first AP and the second AP may honor each other's SPs. Additionally, or alternatively, STAs associated with the first AP and the second AP may also honor these SPs. Although described as a C-R-TWT, any number of other names (such as a coordinated medium access) may be used to describe this concept.

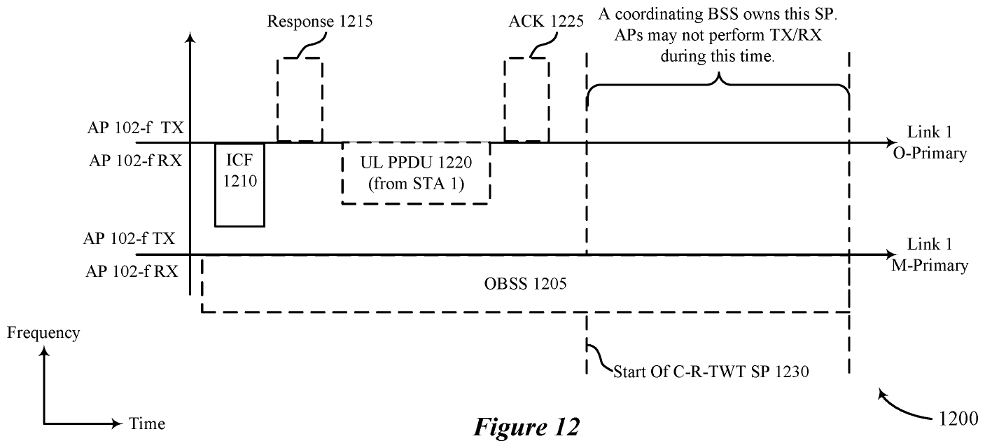

FIG. 12 shows an example of a resource diagram 1200 that supports multi-primary channel access operation. The resource diagram 1200 may implement or be implemented by aspects of the wireless communications network 100 and the resource diagrams 300-1100, as shown and described with reference to FIG. 1 and FIGS. 3-11. For example, some aspects of the resource diagram 1200 may be implemented by a STA (such as one of the STAs 104 described with reference to FIG. 1), and other or the same aspects of the resource diagram 1200 may be implemented by an AP 102-f (such as the AP 102 described with reference to FIG. 1).

In some implementations, an AP 102-f (such as a first wireless device) may receive an OBSS 1205 (such as a first signaling) indicating a reservation (such as a first reservation) of a first TXOP (such as a duration of the OBSS 1205) on the M-Primary channel of Link 1. The OBSS 1205 may indicate an ending time of the first TXOP. The AP 102-f may determine that the M-Primary channel of Link 1 is busy and may switch communications (such as switching the main radio) to an O-Primary channel of Link 1. The AP 102-f may receive the OBSS 1205 from a STA that may not support R-TWT.

In some implementations, the AP 102-f may receive an ICF 1210 (such as a second signaling). For example, the AP 102-f may receive the ICF 1210 from an STA via the O-Primary channel (such as a second primary channel) of Link 1. The ICF 1210 may indicate a second reservation of a second TXOP. The ending time of the second TXOP (such as when the AP 102-f ends or terminates the second TXOP) may occur prior to the ending time of the OBSS 1205. Additionally, or alternatively, the ending time of the second TXOP may occur prior to a start of a C-R-TWT SP 1230. The C-R-TWT SP 1230 may be scheduled on the same link (such as Link 1).

In some implementations, the AP 102-f may transmit or receive one or more packets during the second TXOP. For example, the AP 102-f may transmit a response 1215 to the ICF 1210. The AP 102-f may receive an UL PPDU 1220 from an STA. Additionally, or alternatively, the AP 102-f may transmit an ACK 1225 in response to the UL PPDU 1220. The one or more packets may be communicated (such as transmitted or received) during the second TXOP and prior to the start of the C-R-TWT SP 1230 (such as in accordance with the second signaling). As such, the STA may end the TXOP on O-Primary before C-R-TWT SP on the same link.

In some implementations, a coordinating BSS may own the C-R-TWT SP 1230. Thus, AP's BSS may not perform transmissions or receptions during this time. That is, the TD may be 0. For instance, the TD may be 0 since the AP 102-f may not participate, or may be deprioritized, in the C-R-TWT SP 1230.

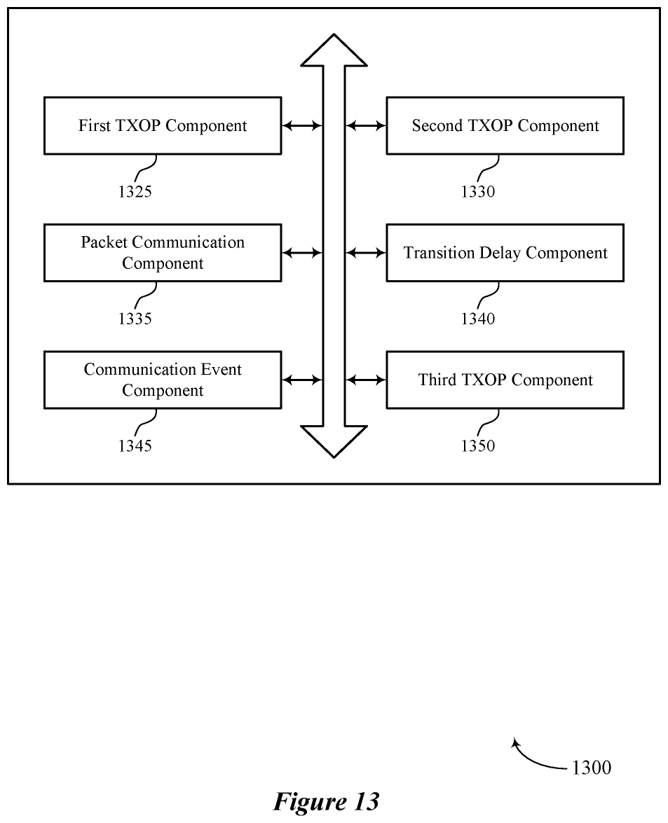

FIG. 13 shows a block diagram of an example wireless communication device 800 that supports multi-primary channel access operation. In some implementations, the wireless communication device 800 is configured to perform the process 900 described with reference to FIG. 9. The wireless communication device 800 may include one or more chips, SoCs, chipsets, packages, components or devices that individually or collectively constitute or include a processing system. The processing system may interface with other components of the wireless communication device 800, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 800 may transmit the information output from the chip. In such an example, the second interface may refer to an interface between the processing system of the chip and a reception component, such that the wireless communication device 800 may receive information that is then passed to the processing system. In some such examples, the first interface also may obtain information, such as from the transmission component, and the second interface also may output information, such as to the reception component.

The processing system of the wireless communication device 800 includes processor (or “processing”) circuitry in the form of one or multiple processors, microprocessors, processing units (such as central processing units (CPUs), graphics processing units (GPUs) or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some implementations, the wireless communication device 800 can configurable or configured for use in an AP or STA, such as the AP 102 or the STA 104 described with reference to FIG. 1. In some other examples, the wireless communication device 800 can be an AP or STA that includes such a processing system and other components including multiple antennas. The wireless communication device 800 is capable of transmitting and receiving wireless communications in the form of, for example, wireless packets. For example, the wireless communication device 800 can be configurable or configured to transmit and receive packets in the form of physical layer PPDUs and MPDUs conforming to one or more of the IEEE 802.11 family of wireless communication protocol standards. In some other examples, the wireless communication device 800 can be configurable or configured to transmit and receive signals and communications conforming to one or more 3GPP specifications including those for 5G NR or 6G. In some implementations, the wireless communication device 800 also includes or can be coupled with one or more application processors which may be further coupled with one or more other memories. In some implementations, the wireless communication device 800 further includes a user interface (UI) (such as a touchscreen or keypad) and a display, which may be integrated with the UI to form a touchscreen display that is coupled with the processing system. In some implementations, the wireless communication device 800 may further include one or more sensors such as, for example, one or more inertial sensors, accelerometers, temperature sensors, pressure sensors, or altitude sensors, that are coupled with the processing system. In some implementations, the wireless communication device 800 further includes at least one external network interface coupled with the processing system that enables communication with a core network or backhaul network that enables the wireless communication device 800 to gain access to external networks including the Internet.

The wireless communication device 800 includes a first TXOP component 825, a second TXOP component 830, a packet communication component 835, a transition delay component 840, a communication event component 845, and a third TXOP component 850. Portions of one or more of the first TXOP component 825, the second TXOP component 830, the packet communication component 835, the transition delay component 840, the communication event component 845, and the third TXOP component 850 may be implemented at least in part in hardware or firmware. For example, one or more of the first TXOP component 825, the second TXOP component 830, the packet communication component 835, the transition delay component 840, the communication event component 845, and the third TXOP component 850 may be implemented at least in part by at least a processor or a modem. In some implementations, portions of one or more of the first TXOP component 825, the second TXOP component 830, the packet communication component 835, the transition delay component 840, the communication event component 845, and the third TXOP component 850 may be implemented at least in part by a processor and software in the form of processor-executable code stored in memory.

The wireless communication device 800 may support wireless communication in accordance with examples as disclosed herein. The first TXOP component 825 is configurable or configured to receive a first signaling indicating a first reservation of a first transmission opportunity for a second wireless device on a first primary channel of a first bandwidth, the first bandwidth including a first set of multiple channels that are reservable via the first primary channel, the first signaling indicating an ending time of the first reservation. The second TXOP component 830 is configurable or configured to transmit or receive, via a second primary channel, a second signaling indicating a second reservation of a second transmission opportunity, where an ending time of the second transmission opportunity occurs prior to the ending time of the first reservation and prior to a start of a transition delay associated with a communication event scheduled on one of the first set of multiple channels or on one of a second set of multiple channels of a second bandwidth.

In some implementations, the packet communication component 835 is configurable or configured to transmit or receive one or more packets, during the second transmission opportunity, prior to the ending time of the second transmission opportunity in accordance with the second signaling.

In some implementations, the transition delay be associated with switching from the second primary channel to the first primary channel. In some implementations, the communication event be scheduled on one of the first set of multiple channels.

In some implementations, the transition delay be associated with switching from the second primary channel to the first primary channel. In some implementations, the communication event be scheduled on one of the second set of multiple channels.

In some implementations, the first set of multiple channels and the second set of multiple channels be associated with a non-simultaneous transmit and receive link pair, an enhanced multi-link single radio link set, or an enhanced multi-link multi radio link set.

In some implementations, the transition delay be associated with an enhanced multi-link single radio transition delay or an enhanced multi-link multi radio transition delay.

In some implementations, the transition delay be indicated in one or more management frames.

In some implementations, the third TXOP component 850 is configurable or configured to receive a third signaling indicating a third reservation of a third transmission opportunity, where a second communication event is scheduled to occur during the third transmission opportunity on one of the first set of multiple channels or on one of the second set of multiple channels. In some implementations, the packet communication component 835 is configurable or configured to transmit a response to the second signaling, where the response indicates a refusal to communicate during at least a portion of the third transmission opportunity.

In some implementations, the third TXOP component 850 is configurable or configured to receive, from the second wireless device or from a third wireless device, a third signaling indicating a third reservation of a third transmission opportunity, where a second communication event is scheduled to occur during the third transmission opportunity on one of the first set of multiple channels or on one of the second set of multiple channels. In some implementations, the packet communication component 835 is configurable or configured to transmit an instruction to the second wireless device or the third wireless device to refrain from transmitting during at least a portion of the third transmission opportunity.

In some implementations, the third TXOP component 850 is configurable or configured to receive a third signaling indicating a third reservation of a third transmission opportunity, where a second communication event is scheduled to occur during the third transmission opportunity on one of the first set of multiple channels or on one of the second set of multiple channels. In some implementations, the packet communication component 835 is configurable or configured to refrain from transmitting a response to the third signaling based on the second communication event being scheduled to occur during the third transmission opportunity.

In some implementations, the second communication event be a dynamic event.

In some implementations, the transition delay be zero.

In some implementations, the communication event be a target beacon transmission beam scheduled on one of the first set of multiple channels or one of the second set of multiple channels, a target wake time service period scheduled on one of the first set of multiple channels, or a target wake time service period scheduled on one of the second set of multiple channels.

In some implementations, the communication event be a restricted target wake time service period associated with the first primary channel that applies to the second primary channel or a coordinated restricted target wake time service period associated with the first primary channel that applies to the second primary channel.

In some implementations, the communication event is a coordinated restricted target wake time service period associated with the first primary channel, and the communication event component 845 is configurable or configured to transmit or receive a third signaling indicating whether the communication event applies to the second primary channel, a third primary channel of the second bandwidth, or any combination thereof.

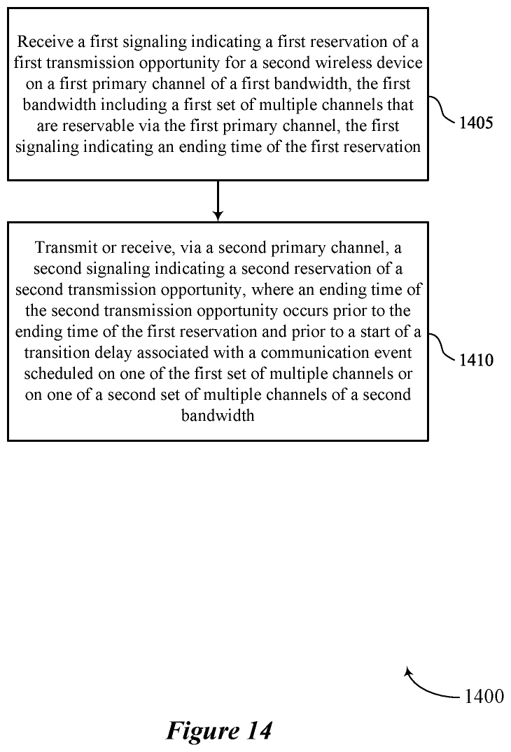

FIG. 14 shows a flowchart illustrating an example process 900 performable by or at a first wireless device that supports multi-primary channel access operation. The operations of the process 900 may be implemented by a first wireless device or its components as described herein. For example, the process 900 may be performed by a wireless communication device, such as the wireless communication device 800 described with reference to FIG. 8, operating as or within a wireless AP or a wireless STA. In some implementations, the process 900 may be performed by a wireless AP or a wireless STA, such as one of the APs 102 or the STAs 104 described with reference to FIG. 1.

In some implementations, in block 905, the first wireless device may receive a first signaling indicating a first reservation of a first transmission opportunity for a second wireless device on a first primary channel of a first bandwidth, the first bandwidth including a first set of multiple channels that are reservable via the first primary channel, the first signaling indicating an ending time of the first reservation. The operations of block 905 may be performed in accordance with examples as disclosed herein. In some implementations, aspects of the operations of block 905 may be performed by a first TXOP component 825 as described with reference to FIG. 8.

In some implementations, in block 910, the first wireless device may transmit or receive, via a second primary channel, a second signaling indicating a second reservation of a second transmission opportunity, where an ending time of the second transmission opportunity occurs prior to the ending time of the first reservation and prior to a start of a transition delay associated with a communication event scheduled on one of the first set of multiple channels or on one of a second set of multiple channels of a second bandwidth. The operations of block 910 may be performed in accordance with examples as disclosed herein. In some implementations, aspects of the operations of block 910 may be performed by a second TXOP component 830 as described with reference to FIG. 8.

The following provides an overview of aspects of the present disclosure:

Aspect 1: A method for wireless communication at a first wireless device, comprising: receiving a first signaling indicating a first reservation of a first transmission opportunity for a second wireless device on a first primary channel of a first bandwidth, the first bandwidth comprising a first plurality of channels that are reservable via the first primary channel, the first signaling indicating an ending time of the first reservation; and transmitting or receiving, via a second primary channel, a second signaling indicating a second reservation of a second transmission opportunity, wherein an ending time of the second transmission opportunity occurs prior to the ending time of the first reservation and prior to a start of a transition delay associated with a communication event scheduled on one of the first plurality of channels or on one of a second plurality of channels of a second bandwidth.

Aspect 2: The method of aspect 1, further comprising: transmitting or receiving one or more packets, during the second transmission opportunity, prior to the ending time of the second transmission opportunity in accordance with the second signaling.

Aspect 3: The method of any of aspects 1 through 2, wherein the transition delay is associated with switching from the second primary channel to the first primary channel, and the communication event is scheduled on one of the first plurality of channels.

Aspect 4: The method of any of aspects 1 through 2, wherein the transition delay is associated with switching from the second primary channel to the first primary channel, and the communication event is scheduled on one of the second plurality of channels.

Aspect 5: The method of aspect 4, wherein the first plurality of channels and the second plurality of channels are associated with a non-simultaneous transmit and receive link pair, an enhanced multi-link single radio link set, or an enhanced multi-link multi radio link set.

Aspect 6: The method of aspect 5, wherein the transition delay is associated with an enhanced multi-link single radio transition delay or an enhanced multi-link multi radio transition delay.

Aspect 7: The method of any of aspects 4 through 6, wherein the transition delay is indicated in one or more management frames.

Aspect 8: The method of any of aspects 1 through 7, further comprising: receiving a third signaling indicating a third reservation of a third transmission opportunity, wherein a second communication event is scheduled to occur during the third transmission opportunity on one of the first plurality of channels or on one of the second plurality of channels; and transmitting a response to the second signaling, wherein the response indicates a refusal to communicate during at least a portion of the third transmission opportunity.

Aspect 9: The method of any of aspects 1 through 8, further comprising: receiving, from the second wireless device or from a third wireless device, a third signaling indicating a third reservation of a third transmission opportunity, wherein a second communication event is scheduled to occur during the third transmission opportunity on one of the first plurality of channels or on one of the second plurality of channels; and transmitting an instruction to the second wireless device or the third wireless device to refrain from transmitting during at least a portion of the third transmission opportunity.

Aspect 10: The method of any of aspects 1 through 9, further comprising: receiving a third signaling indicating a third reservation of a third transmission opportunity, wherein a second communication event is scheduled to occur during the third transmission opportunity on one of the first plurality of channels or on one of the second plurality of channels; and refraining from transmitting a response to the third signaling based at least in part on the second communication event being scheduled to occur during the third transmission opportunity.

Aspect 11: The method of aspect 10, wherein the second communication event is a dynamic event.

Aspect 12: The method of any of aspects 1 through 11, wherein the transition delay is zero.

Aspect 13: The method of any of aspects 1 through 12, wherein the communication event is a target beacon transmission beam scheduled on one of the first plurality of channels or one of the second plurality of channels, a target wake time service period scheduled on one of the first plurality of channels, or a target wake time service period scheduled on one of the second plurality of channels.

Aspect 14: The method of any of aspects 1 through 12, wherein the communication event is a restricted target wake time service period associated with the first primary channel that applies to the second primary channel or a coordinated restricted target wake time service period associated with the first primary channel that applies to the second primary channel.

Aspect 15: The method of any of aspects 13 through 14, wherein the communication event is a coordinated restricted target wake time service period associated with the first primary channel, the method further comprising: transmitting or receiving a third signaling indicating whether the communication event applies to the second primary channel, a third primary channel of the second bandwidth, or any combination thereof.

Aspect 16: A first wireless device for wireless communication, comprising one or more memories storing processor-executable code, and one or more processors coupled with the one or more memories and individually or collectively operable to execute the code to cause the first wireless device to perform a method of any of aspects 1 through 15.

Aspect 17: A first wireless device for wireless communication, comprising at least one means for performing a method of any of aspects 1 through 15.

Aspect 18: A non-transitory computer-readable medium storing code for wireless communication, the code comprising instructions executable by a processor to perform a method of any of aspects 1 through 15.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A first wireless device, comprising:
a processing system that includes processor circuitry and memory circuitry that stores code, the processing system configured to cause the first wireless device to:
receive a first signaling indicating a first reservation of a first transmission opportunity for a second wireless device on a first primary channel of a first bandwidth, the first bandwidth comprising a first plurality of channels that are reservable via the first primary channel, the first signaling indicating an ending time of the first reservation; and
transmit or receive, via a second primary channel, a second signaling indicating a second reservation of a second transmission opportunity, wherein an ending time of the second transmission opportunity occurs prior to the ending time of the first reservation and prior to a start of a transition delay associated with a communication event scheduled on one of the first plurality of channels or on one of a second plurality of channels of a second bandwidth.

2. The first wireless device of claim 1, wherein the processing system is further configured to cause the first wireless device to:
transmit or receive one or more packets, during the second transmission opportunity, prior to the ending time of the second transmission opportunity in accordance with the second signaling.

3. The first wireless device of claim 1, wherein:
the transition delay is associated with switching from the second primary channel to the first primary channel, and
the communication event is scheduled on one of the first plurality of channels.

4. The first wireless device of claim 1, wherein:
the transition delay is associated with switching from the second primary channel to the first primary channel, and
the communication event is scheduled on one of the second plurality of channels.

5. The first wireless device of claim 4, wherein the first plurality of channels and the second plurality of channels are associated with a non-simultaneous transmit and receive link pair, an enhanced multi-link single radio link set, or an enhanced multi-link multi radio link set.

6. The first wireless device of claim 5, wherein the transition delay is associated with an enhanced multi-link single radio transition delay or an enhanced multi-link multi radio transition delay.

7. The first wireless device of claim 4, wherein:
the transition delay is indicated in one or more management frames.

8. The first wireless device of claim 1, wherein the processing system is further configured to cause the first wireless device to:
receive a third signaling indicating a third reservation of a third transmission opportunity, wherein a second communication event is scheduled to occur during the third transmission opportunity on one of the first plurality of channels or on one of the second plurality of channels; and
transmit a response to the second signaling, wherein the response indicates a refusal to communicate during at least a portion of the third transmission opportunity.

9. The first wireless device of claim 1, wherein the processing system is further configured to cause the first wireless device to:
receive, from the second wireless device or from a third wireless device, a third signaling indicating a third reservation of a third transmission opportunity, wherein a second communication event is scheduled to occur during the third transmission opportunity on one of the first plurality of channels or on one of the second plurality of channels; and
transmit an instruction to the second wireless device or the third wireless device to refrain from transmitting during at least a portion of the third transmission opportunity.

10. The first wireless device of claim 1, wherein the processing system is further configured to cause the first wireless device to:
receive a third signaling indicating a third reservation of a third transmission opportunity, wherein a second communication event is scheduled to occur during the third transmission opportunity on one of the first plurality of channels or on one of the second plurality of channels; and
refrain from transmitting a response to the third signaling based at least in part on the second communication event being scheduled to occur during the third transmission opportunity.

11. The first wireless device of claim 10, wherein the second communication event is a dynamic event.

12. The first wireless device of claim 1, wherein:
the transition delay is zero.

13. The first wireless device of claim 1, wherein the communication event is a target beacon transmission beam scheduled on one of the first plurality of channels or one of the second plurality of channels, a target wake time service period scheduled on one of the first plurality of channels, or a target wake time service period scheduled on one of the second plurality of channels.

14. The first wireless device of claim 13, wherein the communication event is a restricted target wake time service period associated with the first primary channel that applies to the second primary channel or a coordinated restricted target wake time service period associated with the first primary channel that applies to the second primary channel.

15. The first wireless device of claim 13, wherein the communication event is a coordinated restricted target wake time service period associated with the first primary channel, and the processing system is further configured to cause the first wireless device to:
transmit or receive a third signaling indicating whether the communication event applies to the second primary channel, a third primary channel of the second bandwidth, or any combination thereof.

16. A first wireless device, comprising:
a processing system that includes processor circuitry and memory circuitry that stores code, the processing system configured to cause the first wireless device to:
transmit a first signaling indicating a first reservation of a first transmission opportunity for a second wireless device on a first primary channel of a first bandwidth, the first bandwidth comprising a first plurality of channels that are reservable via the first primary channel, the first signaling indicating an ending time of the first reservation; and
transmit or receive, via a second primary channel, a second signaling indicating a second reservation of a second transmission opportunity, wherein an ending time of the second transmission opportunity occurs prior to the ending time of the first reservation and prior to a start of a transition delay associated with a communication event scheduled on one of the first plurality of channels or on one of a second plurality of channels of a second bandwidth.

17. The first wireless device of claim 16, wherein the processing system is further configured to cause the first wireless device to:
transmit or receive one or more packets, during the second transmission opportunity, prior to the ending time of the second transmission opportunity in accordance with the second signaling.

18. The first wireless device of claim 16, wherein:
the transition delay is associated with switching from the second primary channel to the first primary channel, and
the communication event is scheduled on one of the first plurality of channels.

19. The first wireless device of claim 16, wherein:
the transition delay is associated with switching from the second primary channel to the first primary channel, and
the communication event is scheduled on one of the second plurality of channels.

20. The first wireless device of claim 19, wherein the first plurality of channels and the second plurality of channels are associated with a non-simultaneous transmit and receive link pair, an enhanced multi-link single radio link set, or an enhanced multi-link multi radio link set.

21. The first wireless device of claim 20, wherein the transition delay is associated with an enhanced multi-link single radio transition delay or an enhanced multi-link multi radio transition delay.

22. The first wireless device of claim 19, wherein:
the transition delay is indicated in one or more management frames.

23. The first wireless device of claim 16, wherein the processing system is further configured to cause the first wireless device to:
transmit a third signaling indicating a third reservation of a third transmission opportunity, wherein a second communication event is scheduled to occur during the third transmission opportunity on one of the first plurality of channels or on one of the second plurality of channels; and
receive a response to the second signaling, wherein the response indicates a refusal to communicate during at least a portion of the third transmission opportunity.

24. The first wireless device of claim 16, wherein the processing system is further configured to cause the first wireless device to:
transmit, from the second wireless device or from a third wireless device, a third signaling indicating a third reservation of a third transmission opportunity, wherein a second communication event is scheduled to occur during the third transmission opportunity on one of the first plurality of channels or on one of the second plurality of channels; and
receive an instruction to the second wireless device or the third wireless device to refrain from transmitting during at least a portion of the third transmission opportunity.

25. The first wireless device of claim 16, wherein the processing system is further configured to cause the first wireless device to:
transmit a third signaling indicating a third reservation of a third transmission opportunity, wherein a second communication event is scheduled to occur during the third transmission opportunity on one of the first plurality of channels or on one of the second plurality of channels.

26. The first wireless device of claim 25, wherein the second communication event is a dynamic event.

27. A method for wireless communication at a first wireless device, comprising:
receiving a first signaling indicating a first reservation of a first transmission opportunity for a second wireless device on a first primary channel of a first bandwidth, the first bandwidth comprising a first plurality of channels that are reservable via the first primary channel, the first signaling indicating an ending time of the first reservation; and
transmitting or receiving, via a second primary channel, a second signaling indicating a second reservation of a second transmission opportunity, wherein an ending time of the second transmission opportunity occurs prior to the ending time of the first reservation and prior to a start of a transition delay associated with a communication event scheduled on one of the first plurality of channels or on one of a second plurality of channels of a second bandwidth.

28. The method of claim 27, further comprising:
transmitting or receiving one or more packets, during the second transmission opportunity, prior to the ending time of the second transmission opportunity in accordance with the second signaling.

29. A method for wireless communication by a first wireless device, comprising:
transmitting a first signaling indicating a first reservation of a first transmission opportunity for a second wireless device on a first primary channel of a first bandwidth, the first bandwidth comprising a first plurality of channels that are reservable via the first primary channel, the first signaling indicating an ending time of the first reservation; and
transmitting or receiving, via a second primary channel, a second signaling indicating a second reservation of a second transmission opportunity, wherein an ending time of the second transmission opportunity occurs prior to the ending time of the first reservation and prior to a start of a transition delay associated with a communication event scheduled on one of the first plurality of channels or on one of a second plurality of channels of a second bandwidth.

30. The method of claim 29, further comprising:
transmitting or receiving one or more packets, during the second transmission opportunity, prior to the ending time of the second transmission opportunity in accordance with the second signaling.
